(19) United States
(12) Patent Application Publication
(10) Pub. No.: US 2015/0112664 A1
(43) Pub. Date: Apr. 23, 2015

(54) SYSTEM AND METHOD FOR GENERATING A TRACTABLE SEMANTIC NETWORK FOR A CONCEPT

(71) Applicant: Venkat Srinivasan, Weston, MA (US)

(72) Inventor: Venkat Srinivasan, Weston, MA (US)

(73) Assignee: RAGE FRAMEWORKS, INC., Dedham, MA (US)

(21) Appl. No.: 14/580,744

(22) Filed: Dec. 23, 2014

Related U.S. Application Data
(63) Continuation-in-part of application No. 12/963,907, filed on Dec. 9, 2010.

(51) Int. Cl. G06F 17/27

(52) U.S. Cl. CPC G06F 17/2785; G06F 17/2775
USPC 704/9

(57) ABSTRACT

Computer implemented natural language processing systems and methods for generating a semantic network for a specific concept of interest. The method includes identifying co-reference relationships between sentences or clusters of a corpus of documents so as to determine one or more clusters of co-referential sentences. One or more concepts or events are determined from the clauses or sentences of the clusters and relationship identification rules are processed to determine relationships between concepts or events identified in the clusters. Subsequently, the semantic network of the determined relationships is generated.

### CROSS REFERENCE TO RELATED APPLICATIONS

This application is a CIP of U.S. patent application Ser. No. 12/963,907 filed Dec. 9, 2010, the disclosure of which is hereby incorporated by reference. This application is also related to U.S. patent application Ser. No. ______ filed entitled “SYSTEM AND METHOD FOR DOCUMENT CLASSIFICATION BASED ON SEMANTIC ANALYSIS OF THE DOCUMENT” and to U.S. patent application Ser. No. ______ filed entitled “SYSTEM AND METHOD FOR DETERMINING THE MEANING OF A DOCUMENT WITH RESPECT TO A CONCEPT”. The disclosure of these applications are also hereby incorporated by reference.

### TECHNICAL FIELD

The present application relates generally to computer implemented natural language processing technology. In particular, the application relates to system and method for automatically generating a tractable semantic network of related concepts for a concept.

### BACKGROUND

Digital data has been growing at an enormous pace and much of this growth, as much as 80% is unstructured data, mostly text. With such large amounts of unstructured text becoming available both on the public internet and to enterprises internally, there is a significant need to analyze such data and to derive meaningful insight from it. Superior access to information is the key to superior performance in almost any field of endeavor. Understanding the implications if any in such data is obviously a significant need and opportunity. As a result, various techniques are employed in prior art for analyzing such corpuses of unstructured data so as to extract from the corpus and subsequently, retrieve meaningful information from the data.

To facilitate such analysis, a key enabling step is the identification of all related concepts to a concept or topic of interest. To analyze vast amounts of unstructured data to develop insights relating to a specific topic or set of topics, one needs to be able to understand wherever the corpus refers to any concept that is related to the concept of interest. In other words, to gain a rich identification of all the instances where the topic of interest is being discussed, one need not just look for a specific description of that topic but need to look for all possible ways that topic can be expressed in the unstructured corpus and also look for all occurrences of concepts related to the concept of interest. Such a collection of related concepts is referred to as the Semantic Network for that Concept.

Typically, the large majority of semantic analysis based techniques utilize a variety of probabilistic methods to extract information from any corpus. The automated discovery of a semantic network can also utilize one or more such probabilistic methods. However the use of statistical methods has several major challenges. First, such methods are not tractable. The user cannot trace how the related concepts were identified. Second, such methods are unable to incorporate contextual information at a very fine grained level since they do not apply deep linguistic parsing of the text to address issue such as word sense disambiguation. Third, such methods may not always generate meaningful information, given that to enable meaningful use of a semantic network; it must identify how a related concept is related to the concept of interest. This allows for very powerful usage of the semantic network for a variety of practical applications.

Further, prior art techniques focused on automated relationship extraction through linguistic parsing are limited to identification of definitional relationships such as hypernym and hyponym type relationships. These are commonly referred to as Ontologies. These are of very limited use in the context of understanding when different terms are used to mean the same thing. Discourse in the real world is much more complex in nature where writers rely on complex relationships between concepts to communicate their thought. For example, Rhetorical Structure Theory identifies at least thirty (30) different relationships that may exist between concepts and/or events embedded in the corpus.

Another significant challenge in automated machine learning is the need for experts to easily provide their expertise to the machine to enhance automated discovery.

All of the above necessitate the need for an automated method and system for discovering a comprehensive, tractable, configurable semantic network for any topic or concept of interest.

### SUMMARY

According to a first aspect of the invention, disclosed is a method for analyzing text of a document to generate a semantic network for concepts. The method comprises: identifying at least one co-referential relationship between at least two sentences of a plurality of sentences of the document; determining at least one cluster based on the at least one co-referential relationship between the at least two sentences, wherein the at least one cluster comprises co-referential sentences of the document; identifying at least two concepts or events within the co-referential sentences of the document; determining at least one relationship between the at least two concepts or events; and generating an ontology indicating the at least one relationship between the at least two concepts or events.

The generating of the ontology includes generating causal ontology indicating causal relationships between the at least two concepts or events. The causal relationships comprise at least one of direct causal relationships, indirect causal relationships, conditional causal relationships, and implied causal relations.

Further, the at least one relationship between the at least two concepts or events comprises at least one of a causal relationship, conditional relationship, contrast relationship, temporal parallel relationship, temporal succession relationship, temporal simultaneous relationship, contra expectation relationship, reasoning based relationship, justification relationship, elaboration relationship, result based relationship, conclusion based relationship, comparison relationship, and co-occurrence relation.

According to an aspect of the invention, a method for generating a semantic network for a concept is disclosed. The method comprises: identifying a cluster of co-referential clauses; determining at least one concept or event within a first clause of the cluster of co-referential clauses; determining at least one relationship between the at least one concept or event with another concept or event, wherein the another concept or event is found in the first clause or a second clause of the of the cluster of co-referential clauses; and generating a semantic network based on the determined at least one relationship between the at least one concept or event with another concept or event.

Also disclosed is a system for analyzing text, the system comprising: a co-reference resolution module configured to identify at least one co-referential relationship between at least two sentences of a plurality of the sentences of the document; a cluster determination module configured to determine at least one cluster based on the at least one co-referential relationship wherein the at least one cluster comprises co-referential sentences of the document; and an ontology generation module comprising: a concept identifier configured to identify at least two concepts or events within the co-referential sentences of the document; relationship identification rules comprising information to identify at least one relationship between the at least two concepts or events within the co-referential sentences of the document; and an inference engine configured to generate an ontology indicating the at least one relationship between the at least two concepts or events within the co-referential sentences of the document.

According to an aspect of the invention, a system for managing the relationships identification rules is disclosed. The system comprising: a language processing module configured to execute at least one language processing technique so as to identify at least two concepts or events within at least one set of co-referential clauses of the document; an ontology generation module comprising: relationship identification rules configured to identify at least one relationship between the at least two concepts or events within the at least one set of co-referential clauses; an inference engine configured to generate an ontology indicating the at least one relationship between the at least two concepts or events within the at least one set of co-referential clauses; and a configuration module comprising a first parameter for managing the relationship identification rules, wherein values for the first parameter are provided by a user.

Throughout the above steps, each component of the system is driven by a set of externalized rules and configurable parameters. This makes the system adaptable and extensible without any programming.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

For a more complete understanding of exemplary embodiments of the present invention, reference is now made to the following descriptions taken in connection with the accompanying drawings in which:

FIG. 1 illustrates an exemplary embodiment of a computing device for generating an ontology from a corpus according to one or more embodiments of the invention;

FIG. 2 illustrates an exemplary embodiment of a computing environment for generating the ontology from the corpus according to one or more embodiments of the invention;

FIG. 3 illustrates an exemplary embodiment of a client server computing environment for generating the ontology from the corpus according to one or more embodiments of the invention;

FIG. 4 illustrates an exemplary embodiment of a display interface for depicting the ontology corresponding to a specific concept according to one or more embodiments of the invention;

FIG. 5 illustrates an exemplary embodiment of a functional block diagram for controlling the execution of language processing modules according to one or more embodiments of the invention;

FIG. 6 illustrates an exemplary embodiment of a block diagram for a text processing layer of the language processing modules according to one or more embodiments of the invention;

FIGS. 7A and 7B illustrate an exemplary embodiment of an outcome for an unstructured document at the text processing layer of the language processing modules according to one or more embodiments of the invention;

FIG. 8 illustrates an exemplary embodiment of a block diagram for a natural language processing layer of the language processing modules according to one or more embodiments of the invention;

FIGS. 9A and 9B illustrate an exemplary embodiment of a outcome from one or more modules of the natural language processing layer according to one or more embodiments of the invention;

FIG. 10 illustrates an exemplary embodiment of a block diagram for a linguistic analysis layer of the language processing modules according to one or more embodiments of the invention;

FIGS. 11A 11B and 11C illustrate an exemplary embodiment of an outcome from one or more modules of a linguistic analysis layer according to one or more embodiments of the invention;

FIG. 12 illustrates an exemplary embodiment of a block diagram of an ontology generation module according to one or more embodiments of the invention;

FIG. 13 illustrates an exemplary embodiment of an ontology generated using an ontology generation module according to one or more embodiments of the invention;

FIG. 14 illustrates an exemplary embodiment of a causal ontology generated using an ontology generation module according to one or more embodiments of the invention;

FIG. 15 illustrates an exemplary embodiment of a method for generating a semantic network for a concept according to one or more embodiments of the invention; and

FIG. 16 illustrates another exemplary embodiment of a method for generating a semantic network for a concept according to one or more embodiments of the invention.

### DETAILED DESCRIPTION OF THE DRAWINGS

The systems and methods disclosed herein can be configured to extract a global set of relationships between one or more concepts identified within a corpus and compute a rank of a relative strength of such relationships. Based on the relationships between the one or more concepts identified within the corpus, a semantic network for a particular concept of interest can be created. The semantic network can also be referred to as ontology for the particular concept of interest. In addition, the ontology can be a structure enumerating relationships between the one or more concepts that are causal or definitional in nature. The causal relationships can include direct causal relationships, indirect causal relationships, conditional causal relationships, implied causal relationships and other forms of causal relations. Further, the relationships can be of definitional nature indicating definitional relationships such as synonym, hypernym, meronym or other forms of definitional relationships between the one or more concepts of the corpus.

In an embodiment, the methods and systems disclosed herein can be configured to automatically discover related concepts and the corresponding relationships with the concept of interest in the corpus. For example, the user may be interested in discovering ontology for a particular concept of interest e.g., ‘Consumer Confidence’. Accordingly, the methods and systems disclosed herein can be configured to interrogate the corpus and identify concepts related to ‘Consumer Confidence’ and determine the relationships between the identified concepts and the particular concept of interest i.e., ‘Consumer Confidence’. On determination of the relationships, the ontology is created such that the ontology is an exhaustive enumeration of relationships between the concept of interest and other concepts that are relevant to the particular concept of interest.

In an embodiment, the methods and systems disclosed herein can be configured to access a particular relationship rule and a corresponding definition of the particular relationship rule. For example, the users can access the relationship identification rules and subsequently, modify existing relationship identification rules. In an embodiment, the user can add or remove a specific relationship identification rule and respective definition of the specific relationship identification rule.

In an embodiment, the methods and systems disclosed herein can be configured to identify one or more different variations of the concept so as to normalize the different variations of the concept. In an example, one or more normalization rules can be implemented to identify the one or more instances of the concept of interest. The one or more normalization rules can intelligently reduce complex noun-phrases into specific normalized concepts so that the one or more instances of the concept of interest can be identified and the particular relationship between the one or more instances of the concept of interest and the other concepts can be perceived. Furthermore, the methods and systems disclosed herein can be configured to perform one or more contextual inferences to create a multi-level and hierarchical causal ontology.

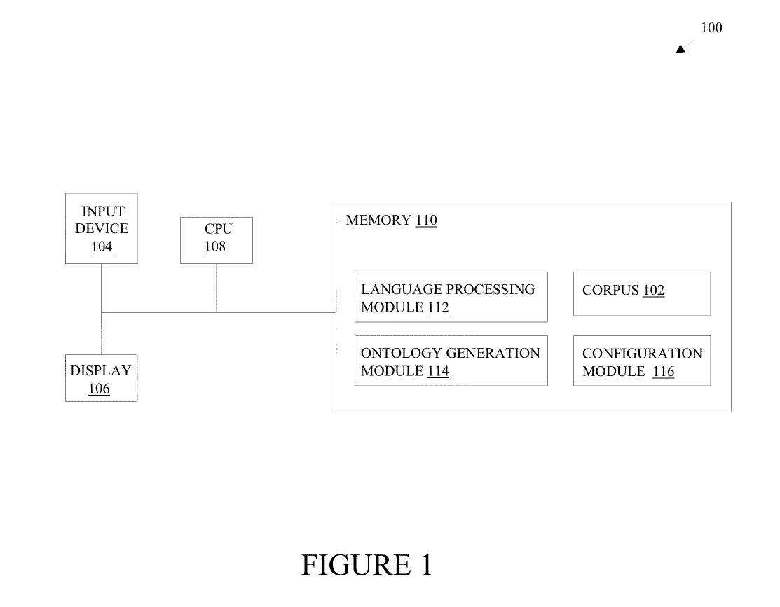

Referring to FIG. 1, an exemplary embodiment of a computing device 100 for generating the ontology from a corpus 102 is disclosed. The computing device 100 can be configured to analyze the corpus 102 such as to identify one or more concepts within the corpus 102 and generate the ontology indicating the relationships between the one or more concepts identified within the corpus 102. In an example, the computing device 100 can be configured to enable a user to search for a concept of interest in the corpus 102. Subsequently, the computing device 100 can be configured to generate the ontology from the corpus 102 based on the concept of interest. In another example, the computing device 100 can be configured to access a portion of the corpus 102 and generate the ontology for the portion of the corpus 102.

In an embodiment, the computing device 100 can be configured to include an input device 104, a display 106, a central processing unit (CPU) 108 and memory 110 coupled to each other. The input device 104 enables the user to enter input that can be used to generate the ontology. The input device 104 can include a keyboard, a mouse, a touchpad, a trackball, a touch panel or any other form of the input device 104 through which the user can provide inputs to the computing device 100. The CPU 108 is preferably a commercially available, single chip microprocessor including such as a complex instruction set computer (CISC) chip, a reduced instruction set computer (RISC) and the like. The CPU 108 is coupled to the memory 110 by appropriate control and address busses, as is well known to those skilled in the art. The CPU 108 is further coupled to the input device 104 and the display 106 by bi-directional data bus to permit data transfers with peripheral devices.

The computing device 100 typically includes a variety of computer-readable media. By way of example, and not limitation, the computer-readable media can comprise Random Access Memory (RAM), Read Only Memory (ROM), Electronically Erasable Programmable Read Only Memory (EEPROM), flash memory other memory technologies; CDROM, digital versatile disks (DVDs) or other optical or holographic media; magnetic cassettes, magnetic tape, magnetic disk storage or other magnetic storage devices; or any other medium that can be used to encode desired information and be accessed by computing device 100.

The memory 110 includes computer-storage media in the form of volatile and/or nonvolatile memory. The memory 110 may be removable, non-removable, or a combination thereof. In an embodiment, the memory 110 includes the corpus 102 and one or more language processing modules 112 such as to process the corpus 102 to generate the ontology. The corpus 102 can include text related information including tweets, facebook postings, emails, claims reports, resumes, operational notes, published documents or combination of any of these so that the text included in the corpus 102 can be processed to generate the ontology for the one or more concepts.

The one or more language processing modules 112 can be configured to process the structured or unstructured text within the corpus 102 at a sentence level, clause level or at phrase level. The language processing modules 112 can further be configured to determine which noun-phrases refer to which other noun-phrases. Accordingly, one or more co-referential sentences or clauses can be determined. Based on the one or more co-referential sentences or clauses, cluster maps are generated at clause level or at sentence level. For example, a clause cluster map can indicate presence of various clusters of one or more co-referential clauses of the document. Similarly, a sentence cluster map can indicate presence of various clusters of one or more co-referential sentences of the document. Additionally, the cluster maps are used to determine presence of one or more concepts within the document of the corpus 102.

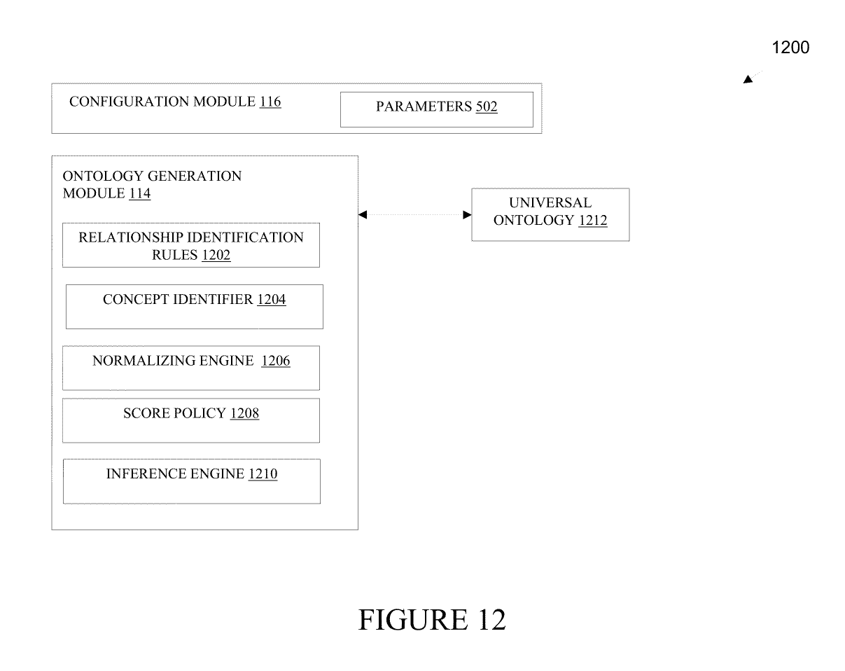

In an embodiment, the ontology generation module 114 can be configured to access one or more clauses of the cluster map. The ontology generation module 114 includes a relationship identification module comprising one or more rules to determine relationships between two concepts. As an example and not as a limitation, the ontology generation module 114 can be configured to access each clause of the cluster map and the relationship identification module determines relationships between the various concepts of the each clause of the cluster map. Further, the ontology generation module 114 can be configured to rank the concepts and generate the network of relationships determined between these concepts. Such network of relationships is referred herein to as the ontology. The ontology generation module 114 is further described in detail in FIG. 12 of this disclosure.

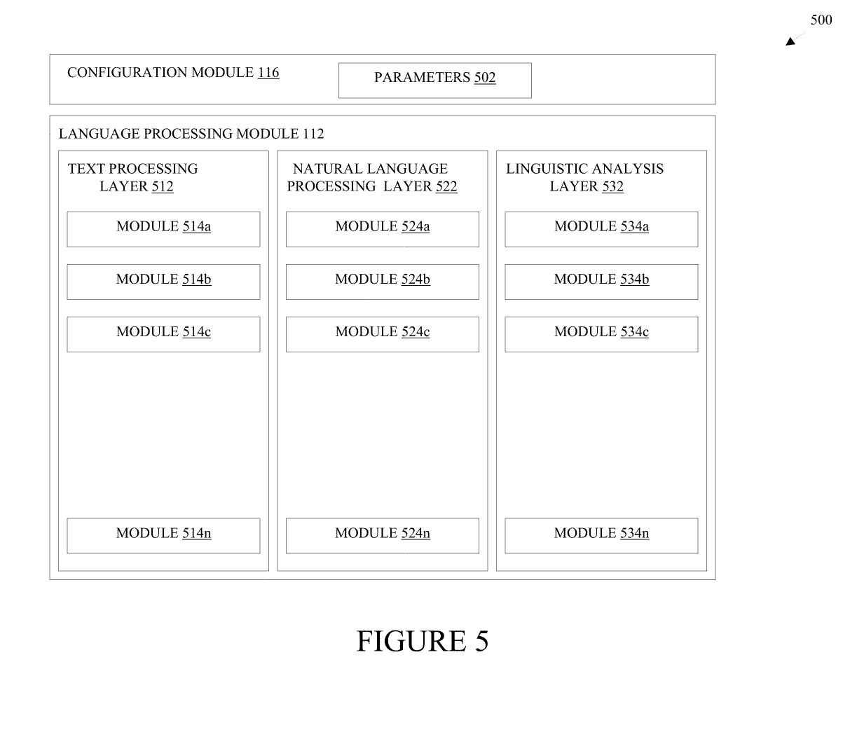

In an embodiment, the memory 110 can be configured to include a configuration module 116 so as to enable the user to input one or more configuration related parameters to control the processing of the language processing modules 112 and the generation of the ontology. In an embodiment, the user may input the parameters in a form of feedback. Accordingly, the computing device 100 can utilize this feedback so as to control the generation of the ontology. For example, the user may indicate using the configuration module 116 a selection of rules that can be used for identification of relationships between the concepts identified within the corpus 102. Subsequently, the ontology generation module 114 can access the configuration module 116 to generate the ontology using only the user selected relationship identification rules. The methods and systems described herein discloses a model based approach wherein the configuration module 116 can be used to control the generation of the ontology and is further described in detail in FIG. 5 of this disclosure.

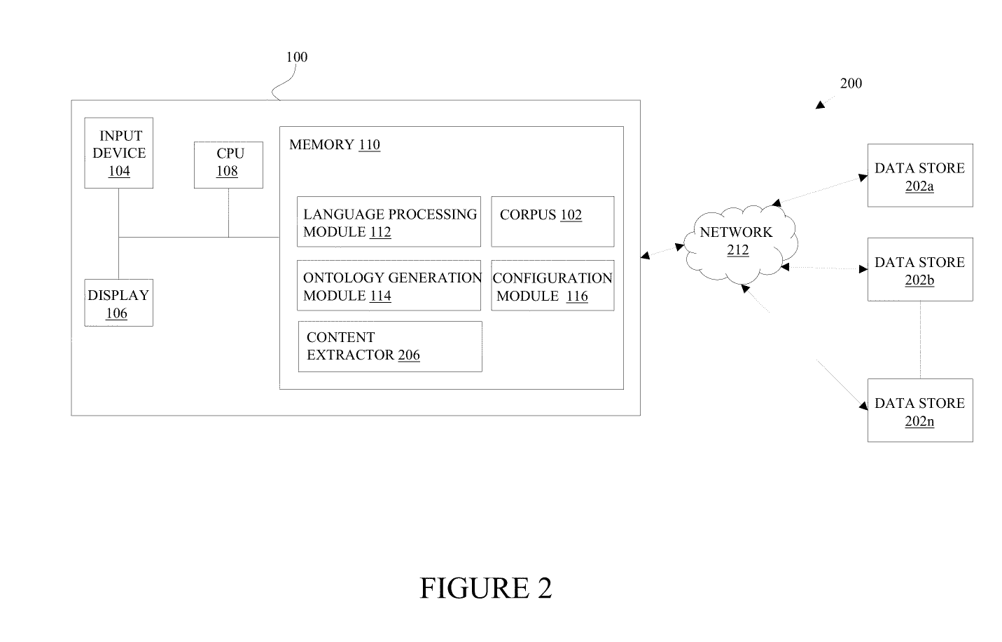

FIG. 2 illustrates an example computing environment 200 for generating the ontology from the corpus 102 according to one or more embodiments of the invention. The computing device 100 can be configured to communicatively coupled to a plurality of data stores such as a data store 202a, data store 202b and a data store 202n (collectively referred herein to as the data store 202) through a network 212. The network 212 can be a wire-line network or wireless network configured to enable the computing device 100 to communicate with the data store 202 so as to extract contents stored therein. In an example, the memory 110 can be configured to include a content extractor 206 to identify content that is required to be extracted from the data store 202.

In an embodiment, the user of the computing device 100 can input a specific concept so as to generate the ontology for the specific concept. Accordingly, the content extractor 206 can be configured to extract content from the data store 202 corresponding to the specific concept. For example, the content extractor 206 can extract various documents, tweets, facebook posts, manuals or any other textual information corresponding to a concept “politics in a war” when the user entered the concept “politics in a war” using the input device 104. The extracted content is processed using the language processing modules language processing modules 112. Subsequently, the ontology generation module 114 can be configured to generate the ontology corresponding to the specific concept using the data store 202.

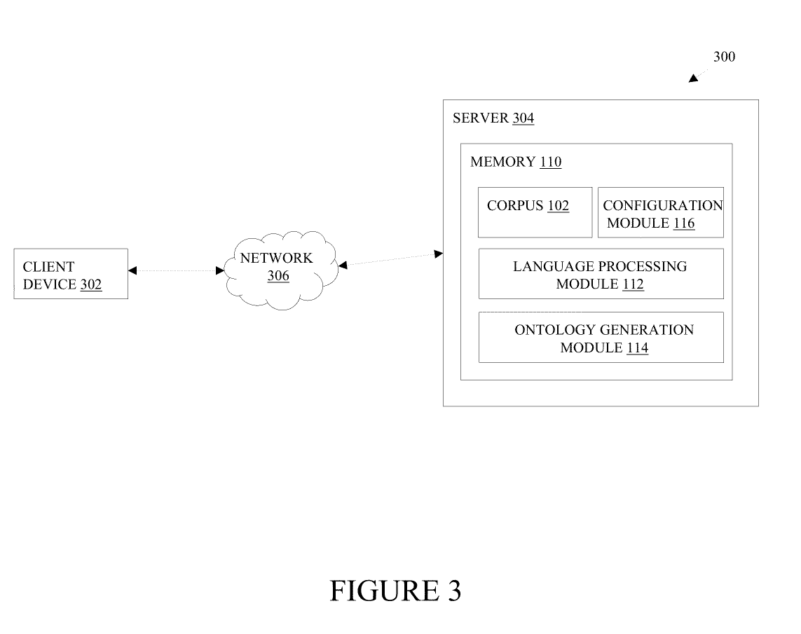

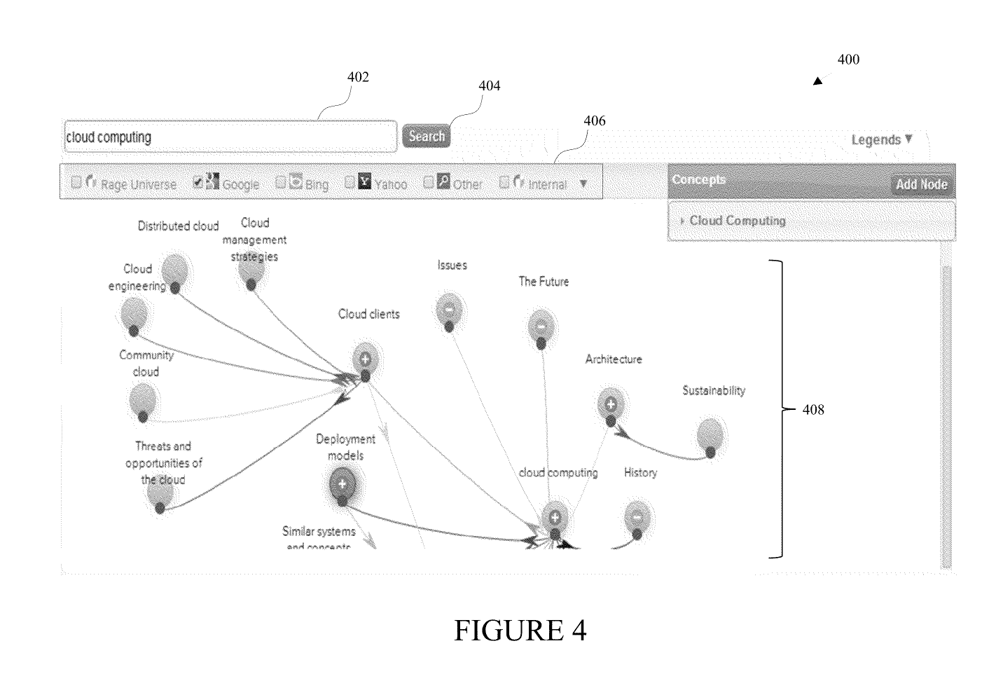

FIG. 3 illustrates an alternative example of a computing environment 300 for generating the ontology from the corpus 102 according to one or more embodiments of the invention. The computing environment 300 is a client server computing environment that includes a client device 302 configured to access a server 304 through a network 306. The client device 302 enables the user to input the specific concept for which the ontology needs to be generated. The client device 302 can include a personal computer, laptop computer, handheld computer, personal digital assistant (PDA), mobile telephone, or any other computing terminal that enable the user to transmit the request to generate the ontology for the specific concept to the server 304. On receiving the request, the server 304 can be configured to process the corpus 102 using the language processing modules 112 and execute the ontology generation module 114 to generate the ontology. Accordingly, the generated ontology for the specific concept is transmitted to the client device client device 302. Consequently, the client device 302 may display the generated ontology to the user in a manner as illustrated in FIG. 4 of this disclosure. Further, the client device 302 can communicate feedback from the user to the server 304 in the configuration module 116 such that the server 304 can be configured to control the generation of the ontology using the configuration module 116.

FIG. 4 illustrates an exemplary embodiment of a display interface 400 for depicting the ontology corresponding to the specific concept according to one or more embodiments of the invention. As illustrated, the user enters the specific concept such as “cloud computing” in a section 402 of the display interface 400 and selects a search button 404 to generate ontology for the “cloud computing”. The display interface 400 can be configured to include one or more options in a section 406 for the user to define the scope of the corpus 102 to generate the ontology. For example, the user can select an option “internal” so as to select an internal corpus to generate the ontology of the cloud computing from the internal corpus. The internal corpus can be the corpus that is available internally to the computing device 100. The user can also be provided an option to select one or more specific documents so that the ontology for the specific concept can be generated from the selected one or more specific documents. Otherwise, the user can select a search engine (e.g., Google, Bing, Yahoo or other search engines) so as to generate the ontology from the corpus that include results obtained from the results of the search engine. As indicated in FIG. 4, the user selects Google as the specific search engine to generate the ontology from the results of the Google search engine. The methods and systems described herein extract the textual information from the content corresponding to the search term “cloud computing”. Subsequently, the methods and systems described herein generate the ontology from the extracted textual information and display the ontology to the user. As indicated, a portion 408 of the display interface 400 depicts the ontology for the cloud computing obtained from the Google results.

The ontology of the “cloud computing” includes one or more nodes such as deployment models, cloud clients, cloud management strategies and other nodes indicating the concepts similar to the “cloud computing”. Each node is shown connected to one or more nodes using a connecting element such as a connecting line. In addition, one or more nodes of the ontology are represented using a plus sign and other nodes are represented by a minus sign. A representation of plus sign for a node (e.g., cloud clients) can indicate the presence of various concepts related to this node i.e., the cloud client's node in the ontology. On selecting the plus sign, the user is provided a display of concepts corresponding to the cloud client's node.

In an embodiment, color and thickness of the connecting line may indicate the type of relationship and strength of the relationships between the two concepts respectively. For example, a connection between the nodes such as cloud clients and cloud management strategies indicate a causal relationship between these nodes. The methods and systems described herein can be configured to extract various relationships between the two concepts. The various relationships between the two concepts can include but not limited to causal, conditional, contrast, temporal parallel, temporal succession, temporal simultaneous, contra expectation, reason, justification, elaboration, result, conclusion, comparison, co-occurrence, or any other relationships that can be required to generate the ontology. The various relationships between the two concepts are further explained in detail in FIG. 12 of this disclosure.

The methods and systems described herein can be configured to analyze different forms of unstructured data (e.g., newspaper articles, industry reports, social-media text, blogs, and others) available in the corpus 102. The methods and systems described herein can be configured to detect events and concepts corresponding to a specific concept of interest and determine the relationships between the identified events and concepts. Subsequently, the methods and systems described herein can be configured to generate a semantic network (i.e., the ontology) for the specific concept of interest such that the semantic network illustrates the relationships between the identified events and concepts corresponding to a specific concept of interest.

FIG. 5 illustrates an exemplary embodiment of a block diagram 500 depicting the processing of the corpus 102 using the language processing modules 112 according to one or more embodiments of the invention. As shown, parameters 502 of the configuration module 116 can be accessed to control the execution of the language processing modules 112. In an embodiment, the language processing modules 112 can be configured to include one or more processing layers such as a text processing layer 512, a natural language processing layer 522 and a linguistic analysis layer 532. The text processing layer 512 can be configured to include one or more modules such as a module 514a, a module 514b, a module 514c and a module 514n such as to execute text level processing of a document identified in the corpus 102. The natural language processing layer 522 can be configured to include one or more modules such as a module 524a, a module 524b, a module 524c and a module 524n so as to derive meaning from the natural language as depicted in the processed text of the document. The linguistic analysis layer 532 can be configured to include one or more modules such as a module 534a, a module 534b, a module 534c and a module 534n such as to determine one or more concepts available in the document.

In an embodiment, the one or more modules of the various layers can be configured to include one or more respective rules for performing one or more operations on the text in the document. For example, the module 514 includes respective rules that are used to perform text related processing in the text processing layer 512. Similarly, the module 534 includes respective rules that are used to determine one or more concepts available in the document in the 534. The methods and systems described herein allow the user to manage the rules corresponding to the respective modules using the configuration module 116. In an embodiment, the user can modify such rules via parameters 502 of the configuration module 116. For example, the user can add or remove any rules for the respective modules via the parameters 502 of the configuration module configuration module 116. As a result, the methods and systems described herein enable the user to control the execution of the language processing modules 112 and thereby provide flexibility of incorporation of feedback from the user.

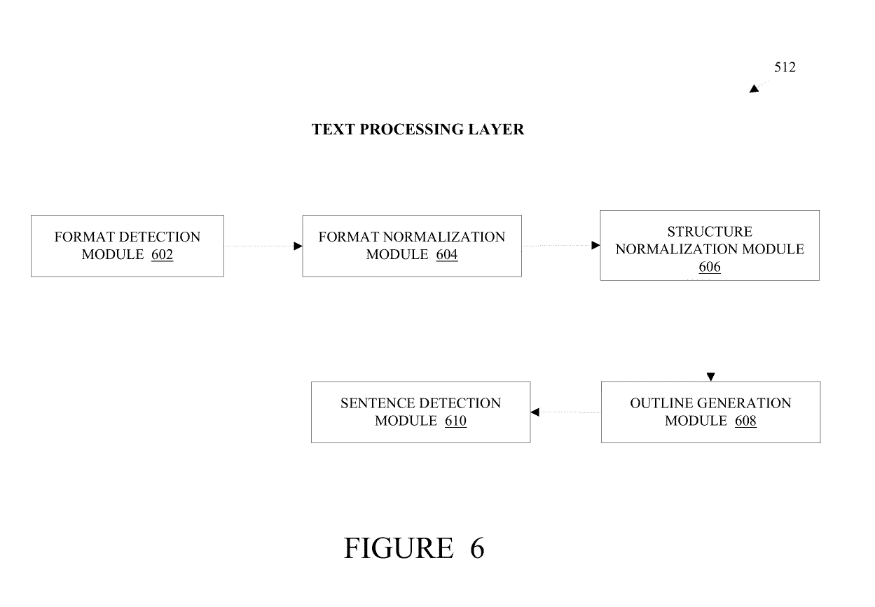

FIG. 6 illustrates an exemplary embodiment of a block diagram for the text processing layer 512 according to one or more embodiments of the invention. The text processing layer 512 can be configured to include one or more modules such as a format detection module 602, a format normalization module 604, a structure normalization module 606, an outline generation module 608 and a sentence detection module 610. In one embodiment, the format detection module 602 can be configured to identify the format of the document. In one embodiment, the document can be accessed from one or more sources such as the corpus 102 or the data store 202. In an example, the document can be accessed based on the input from the user or through a batch processing system. Alternatively, the user can input the document. In one embodiment, the format detection module 602 can be configured to detect the format of the document using format detection techniques employing one or more algorithms such as byte listening algorithm, source-format mapping algorithm or other algorithms.

Subsequently, the format detection module 602 detects the format of the document. The detected format can include one or more image or textual formats such as HTML, XML, XLSX, DOCX, TXT, JPEG, TIFF, or other document formats. Further, the format normalization module 604 can be configured to process the document into a normalized format. In addition, the format normalization module 604 can be configured to implement one or more text recognition techniques such as an optical recognition technique (OCR) to detect text within the document when the format of the document is an image format or one or more images are embedded within the document. In one embodiment, the normalized format of the document can include a format including but not limited to a portable document format, an open office xml format, html format and text format.

In one embodiment, the structure normalization module 606 can be configured to convert the data in the document into a list of paragraphs and other properties (e.g., visual properties such as font-style, physical location on the page, font-size, centered or not, and the like) of the document. Subsequently, the outline generation module 608 can be configured to process the one or more paragraphs of the document. For example, the outline generation module 608 can be configured to convert the one or more paragraphs using one or more heuristic rules into a hierarchical representation (e.g., sections, sub-sections, tables, graphics, and the like) of the document. In addition, the outline generation module 608 can be configured to remove header and footer within the document so as to generate a natural outline for the given document.

Subsequently, the sentence detection module 610 can be configured to perform sentence boundary disambiguation techniques so as to detect sentences within the each textual paragraph of the document. In addition, the sentence detection module 610 can be configured to handle detection of parallel sentences where a sentence is continued in several lists and sub-lists.

In an embodiment, the user can alter such rules for varying the output from the modules of the text processing layer 512 using the parameters 502 of the configuration module parameters 116. For example, the user can specify a domain such as a legal domain using the parameters 502 and accordingly, the outline generation module 608 can be configured to utilize rules associated with the legal domain for generating the hierarchical representation of the document. Further, the user can provide input using the parameters 502 such as to handle OCR errors using the outline generation module 608. In another example, the user can modify the rules for the sentence detection module 610 so as to add or delete rules for detecting sentences within the paragraph of the document. In another example, the user can utilize the parameters 502 so as to modify sentence detection based rules. In another embodiment, the user can enable or disable the execution of any of the modules of the text processing layer 512.

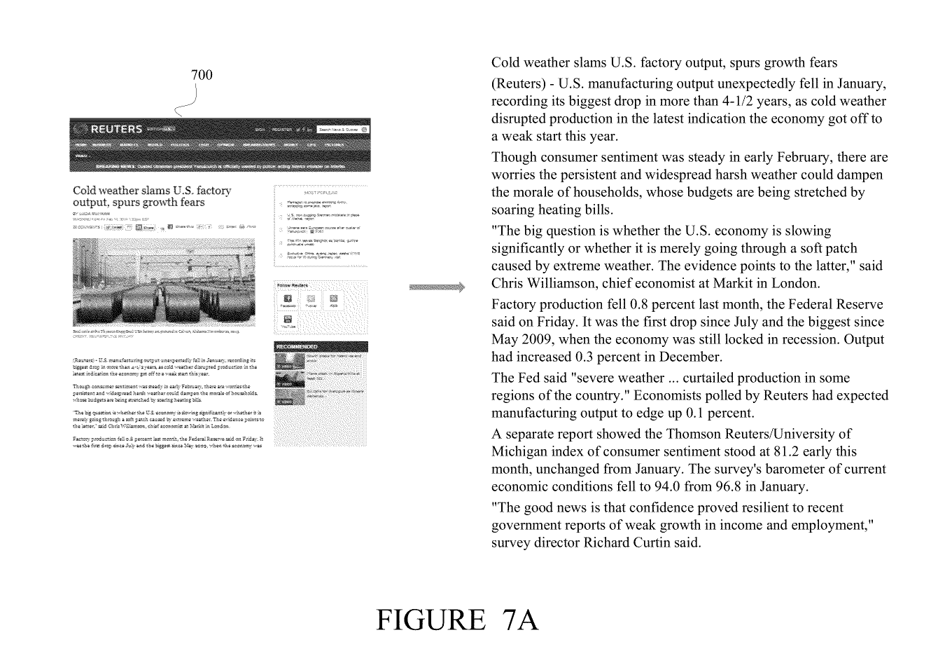

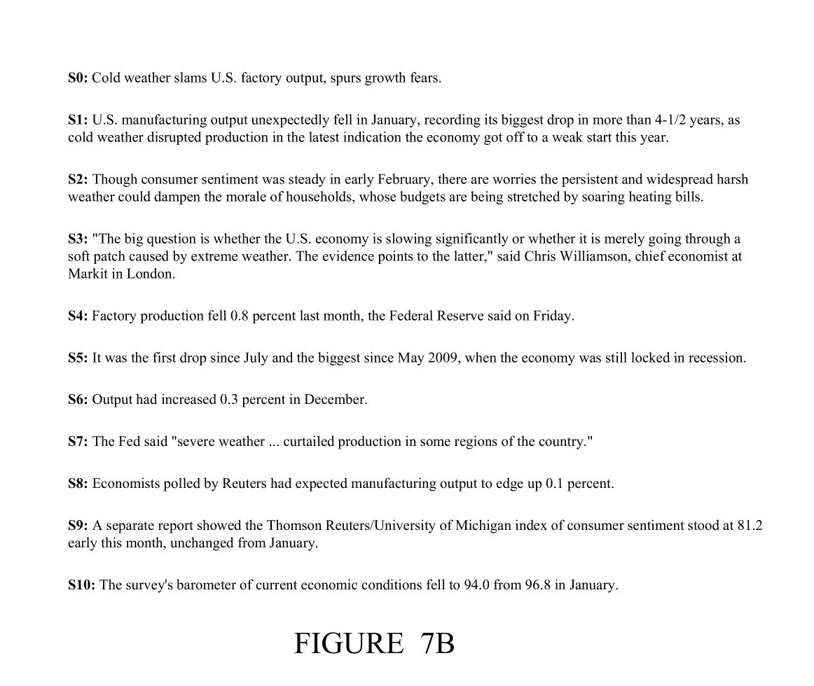

Referring to FIG. 7A, an unstructured document 700 is accessed for processing according to one or more embodiments of the invention. The unstructured document 700 can be extracted from the corpus 102 or from the external data store 202. In an embodiment, the text processing layer 512 can be configured to execute the aforementioned modules on the document 700 so as to extract text related information from the unstructured document 700. As illustrated, the various modules of the text processing layer 512 extract the textual information from the unstructured document. In addition, the sentence detection module 610 can be configured to detect one or more sentences within the extracted text of the unstructured document 700. As illustrated in FIG. 7B, the sentence detection module 610 extracts ten different sentences from the unstructured document 700. Each sentence of the unstructured document 700 is labeled as S0-S10.

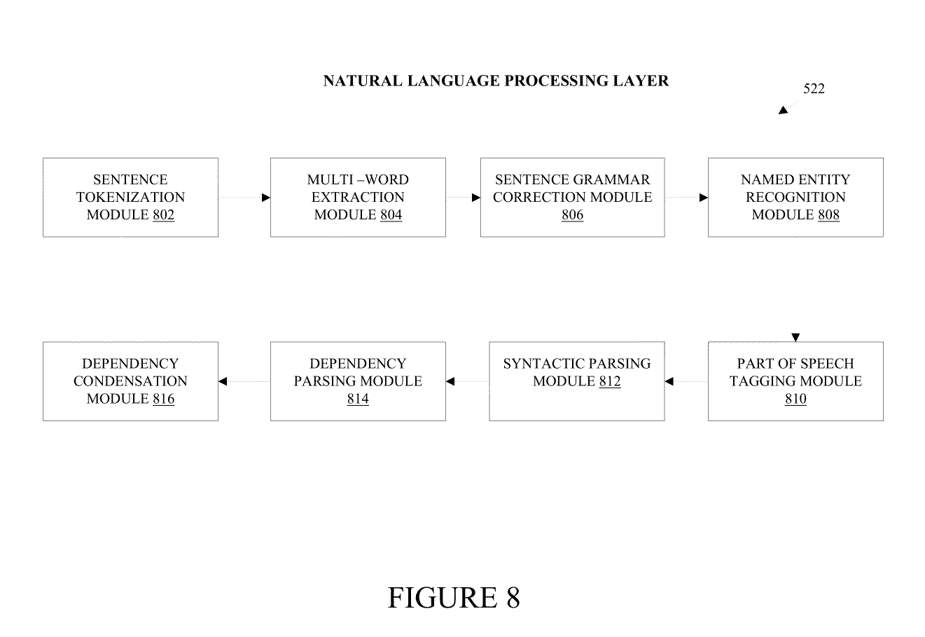

FIG. 8 illustrates an exemplary embodiment of a block diagram for the natural language processing layer 522 according to one or more embodiments of the invention. In one embodiment, the natural language processing layer 522 includes various modules that are configured to determine syntax related processing of the sentences (e.g., S0-S10 of FIG. 7). In one embodiment, the natural language processing layer 522 can be configured to include a sentence tokenization module 802, a multi-word extraction module 804, a sentence grammar correction module 806, a named-entity recognition module 808, a part-of-speech tagging module 810, a syntactic parsing module 812, a dependency parsing module 814, and a dependency condensation module 816.

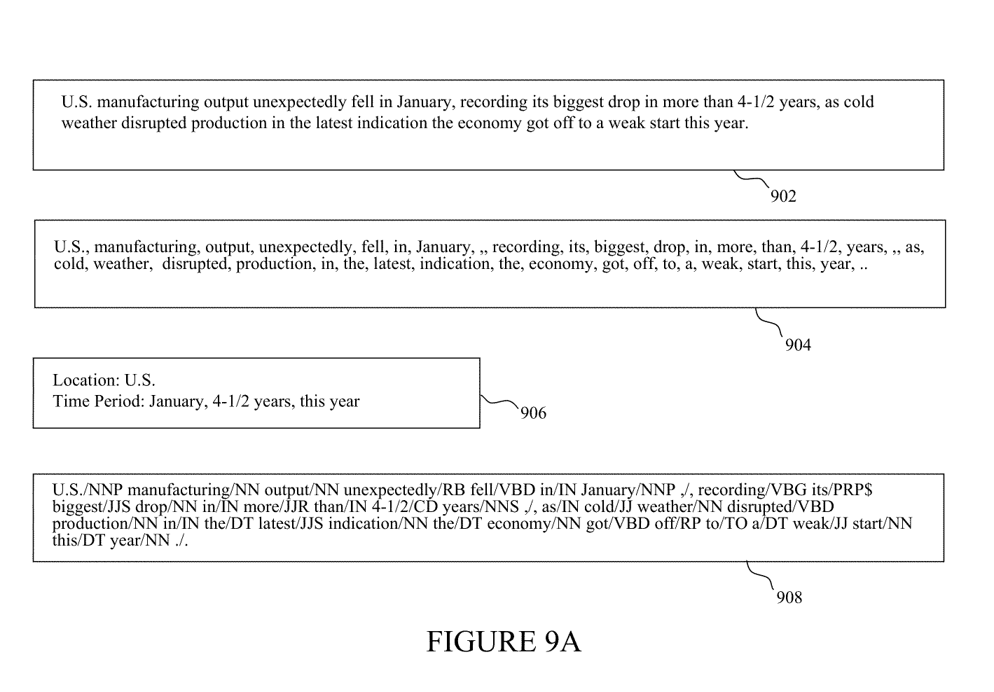

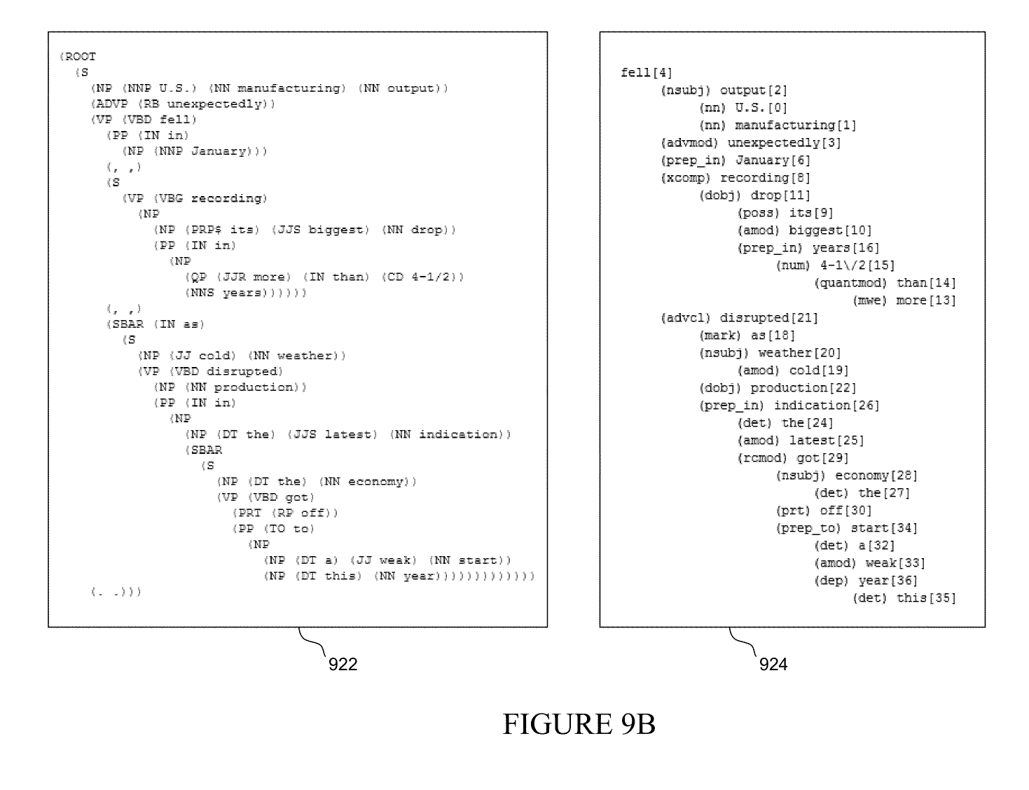

The sentence tokenization module 802 can be configured to segment the sentences into words. Specifically, the sentence tokenization module 802 identifies individual words and assigns a token to each word of the sentence. The sentence tokenization module 802 can further include expanding contractions, correcting common misspellings and removing hyphens that are merely included to split a word at the end of a line. In an embodiment, not only words are considered as tokens, but also numbers, punctuation marks, parentheses and quotation marks. The sentence tokenization module 802 can be configured to execute a tokenization algorithm, which can be augmented with a dictionary-lookup algorithm for performing word tokenization. For example, the sentence tokenization module 802 can be configured to tokenize a sentence as indicated in block 902 of FIG. 9A. Accordingly, an output of the sentence tokenization module 802 for the sentence in the block 902 is illustrated in a block 904. The block 904 depicts each word is segmented using a punctuation (,) for assigning a token.

The multi-word extraction module 804 performs multi-word matching. In an embodiment, for all words that are not articles, such as “the” or “a”, consecutive words may be matched against a dictionary to learn if any matches can be found. If a match is found, the tokens for each of the words can be replaced by a token for the multiple words. In an example, the multi-word extraction module 804 can be configured to execute a multi-word extraction algorithm that can be augmented with a dictionary-lookup algorithm for performing multi-word matching. This is useful but not a necessary step and if the domain of the document from which the sentences are extracted is known, this step can help in better interpretation of certain domain-specific application. For example, if the sentence of the block 902 is subjected to the multi-word extraction module 804, the words like ‘manufacturing output’ and ‘production’ may be identified as matched words and can be assigned a token for the multiple words.

The sentence grammar correction module 806 can be configured to perform text editing function to provide complete predicate structures of sentences that contain subject and object relationships. The sentence grammar correction module 806 is configured to perform the correction of words, phrase or even sentences which are correctly spelled but misused in the context of grammar. In an example, the sentence grammar correction module 806 can be configured to execute a grammar correction algorithm to perform text editing functions. The grammar correction algorithm can be configured to perform at least one of punctuation, verb inflection, single/plural, article and preposition related correction functionalities. For example, if the sentence of the block 902 is subjected to the sentence grammar correction module sentence grammar correction module 806, the sentence 902 may not undergo any changes as the said sentence 902 does not include any grammatical error. However, the sentence grammar correction module 806 can correct any grammatically incorrect sentence subjected thereto.

The named-entity recognition module 808 can be configured to generate named entity classes based on occurrences of named entities in the sentences. For example, the named-entity recognition module 808 can be configured to identify and annotate named entities, such as names of persons, locations, or organizations. The named-entity recognition module 808 can label such named entities by entity type (for example, person, location, time-period or organization) based on the context in which the named entity appears. For example, the named-entity recognition module 808 can be configured to execute a named-entity recognition algorithm, which can be augmented with a dictionary-based named entity lists. This is useful but not a necessary step and if the domain of the document (from which the sentences are extracted) is known, this step can help in better interpretation of certain domain-specific applications. In an example, if the sentence of the block 902 is subjected to the named-entity recognition module 808, the terms like U.S. and January or 4½ years or this year can be classified in the classes such as location and time period respectively. The output is illustrated in a block 906 of FIG. 9A.

The part-of-speech tagging module 810 can be configured to assign a part-of-speech tag or label to each word in a sequence of words. Since many words can have multiple parts of speech, the part-of-speech tagging module 810 must be able to determine the part of speech of a word based on the context of the word in the text. The part-of-speech tagging module 810 can be configured to include a part-of-speech disambiguation algorithm. An output as illustrated in block 908 can be obtained when the sentence in the block 902 is subjected to the part-of-speech tagging module 810. The output in the block 908 indicates the part-of-speech tags associated with every word of the sentence of the block 902.

The syntactic parsing module 812 can be configured to analyze the sentences into its constituents, resulting in a parse tree showing their syntactic relationship to each other, which may also contain semantic and other information. The syntactic parsing module 812 may include a syntactic parser configured to perform parsing of the sentences. In an example, if the sentence of the block 902 is subjected to the syntactic parsing module 812, the sentence of the block 902 can be parsed to show the syntactic relationship as shown in a block 922 of FIG. 9B.

The dependency parsing module 814 can be configured to uniformly present sentence relationships as typed dependency representation. The typed dependencies representation is designed to provide a simple description of the grammatical relationships in a sentence. In an embodiment, every sentence's parse-tree is subjected to dependency parsing. A block 924 of FIG. 9B illustrates an exemplary embodiment of an output of the dependency parsing module 814 when the parse tree of the sentence of block 902 is subjected to the dependency parsing module 814.

In one embodiment, the dependency condensation module 816 can be configured to condense the dependency tree (e.g., the block 924 of the FIG. 9B) so as to join phrases and attributes together. In an example, the dependency tree includes dependencies amongst the tokens of the sentence and the condensed dependency tree (the includes dependencies between phrases (e.g., noun phrases, verb phrases, prepositional phrases and the like) after removing some tokens that exhibit other semantics with the phrases (e.g., attributes such as time-period, quantity, location, and the like). The condensed dependency tree aids in identifying relationship between the phrases.

In an embodiment, the methods and systems described herein enable the user to control the processing of the various modules of the natural language processing layer 522 using the parameters 502 of the configuration module 116. For example, the user can input in the form of the parameters 502 domain for the processing of the modules of the natural language processing layer 522. A legal domain input can restrict the processing of the modules in accordance with rules defined for the legal domain. The user can input multi-word extraction list so as to configure the multi-word extraction module 804 to extract the multi-words using the extraction list as input by the user. Similarly, the user can input list of named entities so as to configure the named entity recognition module 808 to consider the user input while identifying and annotating the named entities.

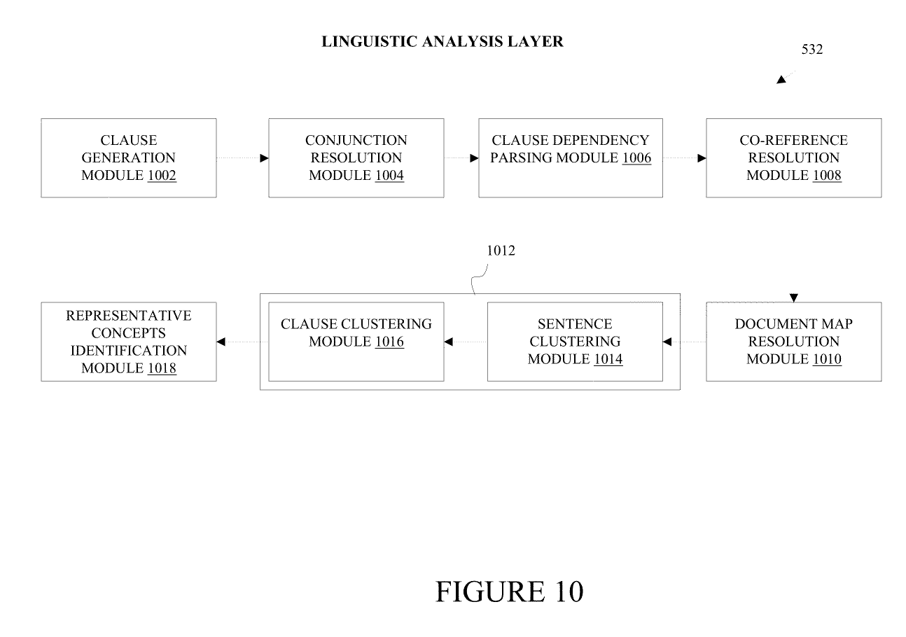

FIG. 10 illustrates an exemplary embodiment of a block diagram for the linguistic analysis layer 532 according to one or more embodiments of the invention. The linguistic analysis layer 532 can be configured to include various modules that are configured to identify clauses and phrases or concepts in the sentences and the correlation there-between. In one embodiment, the linguistic analysis layer 532 includes a clause generation module 1002, a conjunction resolution module 1004, a clause dependency parsing module 1006, a co-reference resolution module 1008, a document map resolution module 1010, a clustering module 1012 including a sentence clustering module 1014 and a clause clustering module 1016, and a representative concepts identification module 1018.

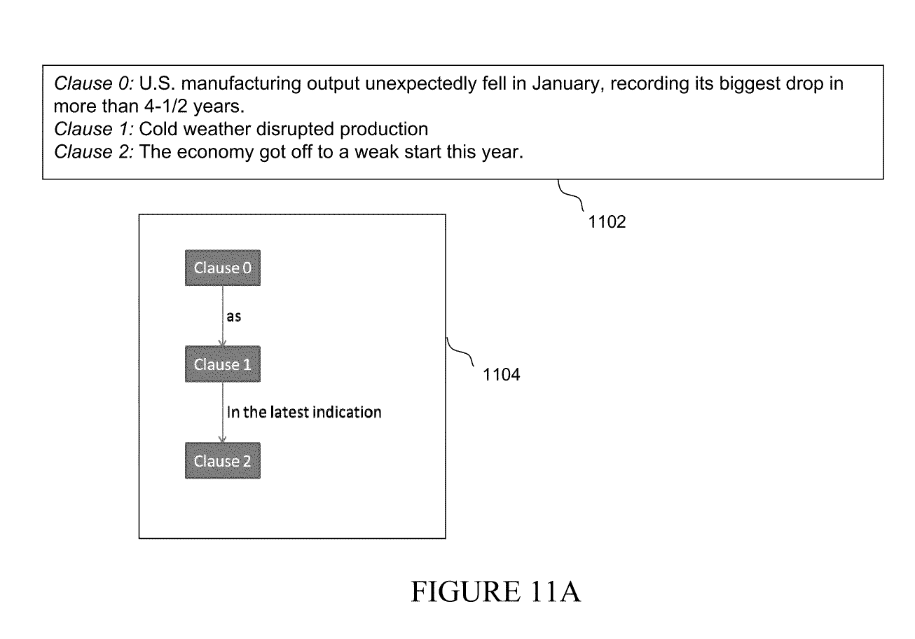

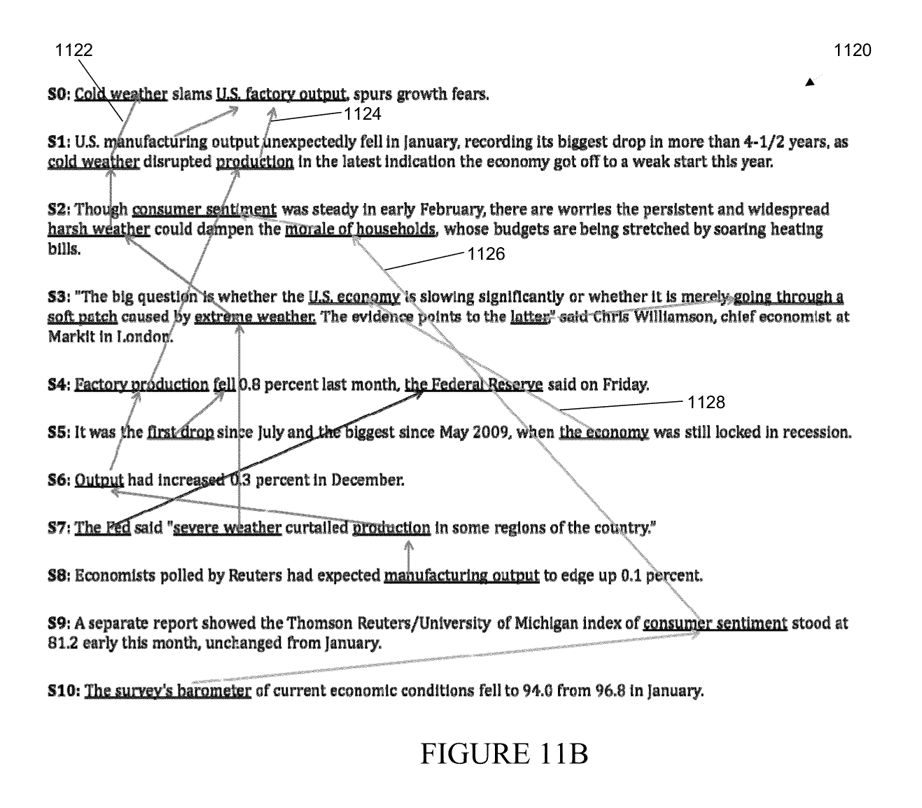

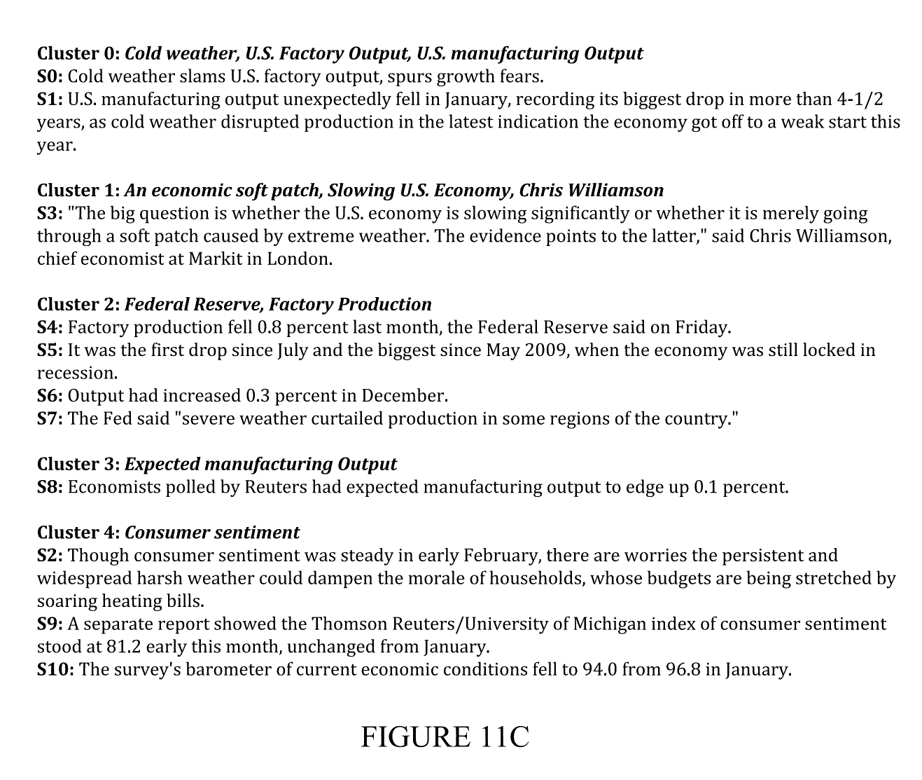

The clause generation module 1002 can be configured to generate meaningful clauses from the sentences. For example, a complex sentence can include various meaningful clauses, and the task of the clause generation module 1002 is to break a sentence into several clauses such that each linguistic clause is an independent unit of information. The clause can also be referred to as a single discourse unit (SDU), which is the independent unit of information. The clause generation module 1002 includes a clause detection algorithm, configured to execute clause boundary detection rules and clause generation rules, for generating the clauses from the sentences. In an example, if the sentence 902 (as shown in FIG. 9A) is subjected to the clause generation module 1002, the sentence of the block 902 is segregated into several clauses, which is depicted in a block 1102 in FIG. 11A. The block 1102 depicts that the sentence of the block 902 is segregated into three clauses, i.e., Clause 0, Clause 1 and Clause 2.

The conjunction resolution module 1004 can be configured to separate sentences with conjunctions into its constituent concepts. For example, if the sentence is “Elephants are found in Asia and Africa”, the conjunction resolution module 1004 split the sentence into two different sub-sentences. The first sub-sentence is “Elephants are found in Asia” and the second sub-sentence is “Elephants are found in Africa”. The conjunction resolution module 1004 can process complex concepts so as to aid normalization.

The clause dependency parsing module 1006 can be configured to parse clauses to generate a clause dependency tree. In an embodiment, the clause dependency parsing module 1006 can be configured to include a dependency parser that is configured to perform the dependency parsing to generate the clause dependency tree. The clause dependency tree can indicate the dependency relationship between the several clauses. In an example, if the sentence of the block 902 is subjected to the clause dependency parsing module 1006, a clause dependency tree can be generated for the various clauses (i.e., Clause 0, Clause 1 and Clause 2) so as to determine dependency relations. An exemplary embodiment of a clause dependency tree is in a block 1104 of FIG. 11A.

The co-reference resolution module 1008 can be configured to identify co-reference relationship between noun phrases of the several clauses. The co-reference resolution module 1008 determines which noun-phrases refer to which other noun-phrases in the several clauses. The co-reference resolution module 1008 can be configured to include a co-reference resolution algorithm configured to execute co-reference detection rules and/or semantic equivalence rules for finding co-reference between the noun phrases. Additionally, the co-reference resolution module 1008 is configured to assign a score to every co-reference relationship based on the type of the co-reference. For example, the co-reference resolution module 1008 may include a co-reference relationship scoring algorithm configured to score every co-reference relationship based on the type of co-reference.

The document map resolution module 1010 can be configured to generate a map based on an output of the co-reference resolution module 1008, i.e., based on the identified co-reference relationships of the noun phrases. In an embodiment, the document map resolution module 1010 can be configured to generate a document map similar to a map 1120 as illustrated in FIG. 11B. The map 1120 is a graph of sentences depicting various co-reference relationships to each other. In an example, if the sentences S0-S10 of the unstructured document 700 are subjected to the co-reference resolution module 1008, the document map resolution module 1010 generates the document map 1120 indicating various co-reference relationships identified between the noun phrases of the sentences S0-S10 of the unstructured document 700.

As shown, the collapsing multiple arrows, such as arrows 1122, 1124, 1126 or 1128, indicate co-reference relationships between the noun phrases of the every the sentences. Additionally, the document map 1120 may depict a score (not shown) based on the strength of co-reference relationship of the noun phrases. For example, every edge between two sentences holds the sum of co-reference scores between the noun-phrases of these two sentences.

Further, based on the co-reference relationship score, the clustering module 1012 can be configured to create cluster of sentences or clauses. In an embodiment, the sentence clustering module 1014 can be configured to cluster the sentences based on the co-reference relationship scores. As shown in FIG. 11C, the several clusters, namely cluster 0 through cluster 4, are formed based on the respective co-reference scores. For example, when the sentences of the document map 1120 are subjected to the sentence clustering module 1014, the cluster 0 through cluster 4 are formed based on the co-reference relationship scores of the noun phrases of the sentences. Specifically, from the document-map 1120, some edges, with weights less than a threshold, are dropped and the resulting graph is a collection of sub-graphs where there are no edges between any two sub-graphs. Each of these sub-graphs is a contextual cluster. The context of a cluster may be identified based on the co-referential noun phrases. Moreover, the threshold that is determined is static and is found using empirical methods using linguistic rules.

In one embodiment, based on the co-reference relationship score clustering of clauses can also be achieved. The clause clustering module 1016 can be configured to cluster the clauses based on the co-reference relationship scores. A specific clause cluster can include one or more clauses that are contextually similar to each other. Further, the clause clustering module 1016 can be configured to generate the clause clusters in a way such that a clause from a first cluster is not in context with another clause in a second cluster. As a result, the clause clusters as generated by the clause clustering module 1016 can eliminate false positives.

Upon formation of the clusters (e.g., the sentence clusters or the clause clusters), the representative concepts identification module representative concepts identification module 1018 can be configured to identify representative concepts for the clusters. The representative concepts of a specific cluster correspond to a main concept of the specific cluster. For example, the representative concepts identification module 1018 identifies noun-phrases in the clusters that can have more linguistic importance than other noun-phrases of the specific cluster. The identified noun phrases are a representation of important concepts disclosed in the specific cluster. Subsequently, the representative concepts can be used for creating the ontology for the document.

In an embodiment, the methods and systems described herein enable the user to control the processing of the various modules of the linguistic analysis layer 532 using the parameters 502 of the configuration module 116. In an example, the user can input the clause generation related configuration parameters for the clause generation module 1002 through the parameters 502 of the configuration module 116. Similarly, the user can modify rules for the conjunction resolution module 1004 for example, by providing a resolution related input for the conjunction resolution module 1004. In an example, the user can input dependency related inputs using the parameters 502 for the clause dependency parsing module 1006. The methods and systems described herein enable the user to input the threshold value for the co-referential scores that can be used to modify the generation of clusters. Such control in the execution of the modules can enable the user to control the input for the ontology generation module 114.

FIG. 12 illustrates an exemplary embodiment of a block diagram 1200 of the ontology generation module 114 according to one or more embodiments of the invention. The ontology generation module 114 can be configured to include a plurality of relationship identification rules 1202 so as to identify one or more relationships between the two or more concepts identified in the document. In an embodiment, the ontology generation module 114 can be configured to include a concept identifier 1204 that can identify one or more concepts or events within the one or more clauses from the set of co-referential sentences of the document. Subsequently, the ontology generation module 114 can be configured to determine the relationships between the identified concepts or events using the relationship identification rules 1202.

In an embodiment, the methods and systems described herein enable the user to modify the relationship identification rules 1202 using the parameters 502 of the configuration module 116. The user can add new relationship types by adding a corresponding rule for the new relationship within the relationship identification rules 1202 and further, define language expressions denoting the relationship. In addition, the methods and systems described herein enable the user to define custom rules for some specific relationships using the parameters 502 of the configuration module 116. For example, the user can define the custom rules when a specific relationship can have different meanings in different domains. As an example and not as a limitation, an obligation in legal domain is a special form of causality with a specific type of linguistic modality. Accordingly, rules corresponding to the causality related relationships can be customized by the user using the parameters 502 of the configuration module 116.

In an embodiment, such customization of the relationships (e.g., modification of existing rules, adding new rules, or removing the existing rules) can be achieved by the user by providing a feedback in the form of parameters 502 of the configuration module 116. For example, the user can input in the form of parameters 502 to ignore one or more relationships while generating the ontology. Alternatively, the user can input in the form of parameters 502 to merge one or more relationships such as various forms of causal relationships to generate the ontology. In addition, the user can input in form of parameters 502 for the ontology generation module 114 to limit to only first few sentences (e.g., 10) from every section (e.g., paragraph) of the document to generate the ontology. Furthermore, the methods and systems described herein enable the user to select a display format for the ontology that will be generated by the ontology generation module 114. In an embodiment, the user can select the desired display format for the ontology using the parameters 502 of the configuration module 116.

In an embodiment, relationship identification rules 1202 can be configured to identify various relationships between the two or more concepts of the document. In an example, the relationship is defined by a set of language related cue words in combination with contextual or collocated words. The relationship identification rules 1202 can be configured to generate a default relationship of co-occurrence between the two concepts of a specific cluster when there does not exist a linguistic relationship between the two concepts of the specific cluster. Such provisioning of adding the default relationship between the two concepts of the specific cluster can improve the tractability of the system. In an example, the relationship identification rules 1202 can be configured to identify attribution related relationships between the concepts. The attribution type relationships can include relationships wherein a named entity A may speak something about a concept B. For example, France said that it will back Palestine on its non-member observer entity status. In this example sentence, a named entity France speaks about the non-member observer entity status.

In an example, the relationship identification rules 1202 can be configured to identify causality related relationships between the concepts. The causality related relationships can include relationships wherein an item A can cause an item B. The items A and B can both be concepts, events or a concept and an event respectively. Both the items (the events and the concepts) map to real-world phenomena, factors, conditions or entities. For example, the stagnant housing industry got a rare boost last month, as more people bought new homes after the worst winter for sales in almost 50 years. In this example sentence, buying homes causes a boost in the stagnant housing industry. Additionally, the causality between the two items can be determined in various ways. A direct causality between the two items can be determined when the item B directly causes an effect in the item A. An indirect causality between the two items can be determined when the item B causes a direct effect in an item C and the item C causes an effect in A. Such type of indirect causality between the items A and B can also be referred to as first (1^{st}) order causality. A conditional causality between the two items can be determined when the item B causes an effect (direct or indirect) in the item A, only when a condition X is satisfied. An implied causality between the two items can be determined when the item A is the result of the effect of causality in the item C, which is caused by the item B.

In an example, the relationship identification rules 1202 can be configured to identify comparison related relationships between the concepts or events. The comparison related relationships can include relationships wherein an event A is compared to an event B. For example, the housing sector continues to lag, whereas other sectors have begun a rebound in earnest. As depicted in this example sentence, a lagging event in the housing sector is compared with a rebound event in other sectors.

In an example, the relationship identification rules 1202 can be configured to identify conclusion related relationships between the concepts or events. The conclusion related relationships can include relationships wherein an event A is a conclusion of an event B. For example, the inflation rate over the longer run is primarily determined by monetary policy and hence the committee has the ability to specify a longer-run goal for inflation. In an example, the relationship identification rules 1202 can be configured to identify conditional relationships between the concepts. The conditional relationships can include relationships wherein an event B occurs when an event A has occurred. For example, if home prices dip again, then consumers may curb their spending. In this example sentence, a curb in spending occurs when the home prices are dipped.

In an example, the relationship identification rules 1202 can be configured to identify contrast related relationships between the concepts. The contrast related relationships can include relationships wherein an event A and an event B can exhibit contrasting behaviors. In an example, the relationship identification rules 1202 can be configured to identify contra-expectation related relationships between the concepts or events. The contra-expectation related relationships can include relationships wherein an event A occurs even when an event B has occurred, which was opposite to the expectations. For example, the housing market continues to remain low, though it did get a significant boost in March. In this example sentence, it was expected that the housing market will grow due to presence of significant boost in March. However, contrary to expectation, housing market continues to remain low.

In an example, the relationship identification rules 1202 can be configured to identify elaboration related relationships between the concepts or events. The elaboration related relationships can include relationships wherein an event A is an elaboration of an event B. For example, Economists forecast that incomes may also rise. In an example, the relationship identification rules 1202 can be configured to identify hypernym related relationships between the concepts or events. The hypernym related relationships can include relationships wherein an event A is a hypernym of an event B. For example, retailers such as Home Depot Inc. In this example phrase, retailers are a hypernym of Home Depot Inc.

In an example, the relationship identification rules 1202 can be configured to identify justification related relationships between the concepts or events. The justification related relationships can include relationships wherein a concept B is used to justify an event on a concept A. In an example, the relationship identification rules 1202 can be configured to identify reasoning related relationships between the concepts or events. The reasoning related relationships can include relationships wherein an event A is a reason of an event B. For example, pending home sales are considered a leading indicator because they track contract signings.

In an example, the relationship identification rules 1202 can be configured to identify result related relationships between the concepts or events. The result related relationships can include relationships wherein an event A is a result of an event B. For example, this raises incomes in the respective foreign countries thus supporting increased sales. In this example sentence, increased sales are the result of the raised incomes. In an example, the relationship identification rules 1202 can be configured to identify temporal simultaneous related relationships between the concepts or events. The temporal simultaneous related relationships can include relationships wherein an event A has occurred simultaneously with an event B. For example, In Bristol, sales dropped 43.8 percent in April compared with the same month last year, while the median sales price fell 3 percent to $225,000. In an example, the relationship identification rules 1202 can be configured to identify temporal succession related relationships between the concepts or events. The temporal succession related relationships can include relationships wherein an event A is succeeded by an event B. For example, many markets began a decline, once those tax credits expired in April.

The following example is depicted to identify the relationships between the concepts involved in the following sentence.

Sentence A: Consumer Confidence in the U.S. fell last week to the lowest level since August as rising prices squeeze household budgets.

As discussed above, the clause generation module 1002 can be configured to determine following clauses within the sentence A.

Clause 1: Consumer Confidence in the U.S. fell last week to the lowest level since August

Clause 2: as rising prices squeeze household budgets

Accordingly, ontology generation module 114 is executed to determine the following relationships between the concepts namely rising prices, household budgets and consumer confidence.

Relationship 1: [Rising Prices] CAUSES [Household Budgets]

Relationship 2: [Rising Prices] CAUSES an effect on [Household Budgets]

Relationship 3: [Derived] [Household Budgets] CAUSES an effect on [Consumer Confidence]

In an embodiment, the concept identifier 1204 can be configured to identify complex noun phrases such as United Sates of America, Confidence of consumers, US manufacturing output, US factory output and the like as shown in FIG. 11B. In an example, the concept identifier 1204 can be configured to include one or more instructions so as to identify the one or more complex noun phrases within the document. The one or more instructions can include an instruction to consider two tokens with Particle Of Speech (POS)-tags starting with NN as a compound concept, an instruction to identify a concept “A preposition B” as a compound concept when the “B” does not include any other preposition in the sub-tree headed by B and other instructions to identify the compound concepts within the document. Further, the ontology generation module 114 can be configured to include a normalizing engine 1206 to reduce the compound concepts (i.e., the complex noun phrases) into specific normalized concepts, so that different relationships about the same event or concept can be perceived. In an embodiment, the normalizing engine 1206 can be configured to normalize the complex noun phrases for a similar concept or event across the documents. The normalizing engine 1206 can be configured to process the complex noun phrases using one or more normalizing rules so as to recognize concepts that are semantically same but are represented differently within the document. For example, in a first normalizing rule, the normalizing engine 1206 can be configured to represent a specific complex noun phrase “A preposition B” as BA. Similarly, another specific complex noun phrase “A preposition B preposition C” is represented as CBA using the one or more normalizing rules. Subsequently, the normalizing engine 1206 can be configured to consider two compound concepts with same tokens, in any order as the same concept. For example, the normalizing engine 1206 can be configured to treat a noun phrase “consumer confidence” and another phrase “confidence of consumer” as a representative of a single concept consumer confidence.

In an embodiment, the ontology generation module 114 can be configured to include a score policy 1208 so as to associate a score with each of the identified relationships. The score policy 1208 can derive the score either automatically or using feedback from the user in the form of parameters 502 of the configuration module 116. In an example, the score can be directly proportional to an evidence of a specific relationship in the corpus 102. For example, the score policy 1208 can include rules to accentuate the score of the specific relationship between the two concepts X and Y when the corpus 102 (i.e., a database of already identified relationships) already includes sufficient evidence of a relationship between X and Y. In another example, an adaptive score is associated with each relationship as identified by the ontology generation module 114. For example, the score policy 1208 can include rules to adapt the score of the relationship between the concepts depending on the positioning of the concepts within the document. For example, a specific relationship between the concepts appearing in the top of the document can have a relatively higher score than a relationship between the concepts that appear in the middle of the document. Further, the score policy 1208 can include rules to consider other positions of the concepts such as the position of the concepts within the cluster, in the clause dependency tree, document map and the like while associating the score with the relationships between the concepts.

In an embodiment, the ontology generation module 114 can be configured to include an inference engine 1210 that can perform several contextual inferences to create a multi-level, hierarchical, causal ontology. In an embodiment, the ontology indicates one or more relationship between the one or more concepts or events and the other concepts or events. For example, the inference engine 1210 utilizes the various relationships between the concepts (determined using the relationship identification rules 1202) and the respective scores of these relationships to generate the ontology for a specific concept. In an example, the inference engine 1210 can be configured to infer transitive relationships between the two concepts. If a concept A causes a concept B and the concept B causes a concept C, then inference engine 1210 can infer a transitive relationship between the concept A and the concept C to indicate that the concept A transitively causes the concept C. In another example, the inference engine 1210 can be configured to infer commutative relationships between the two concepts or events. If an event X is a parallel of an event Y, then the inference engine 1210 can be configured to determine commutative relationship between the two events X and Y to indicate that the event Y is also a parallel of the event X. The inference engine 1210 can be configured to infer a type of relationship between the two concepts. For example, if A is an example of B and C is an example of B, then A and C are of similar type.

In an embodiment, the inference engine 1210 can be configured to perform inferences on the relationships while considering an extent of the inferential relationship. For example, if the concept A causes the concept B with strength of 80 percent, the inference engine 1210 can be configured to determine that the concept B causes the concept C with strength lesser than the strength of 80 percent. In other words, an increase in a depth of a semantic network of the concepts can reduce the strength of inferential relationships between the concepts.

Optionally, one or more modules of the ontology generation module 114 can be operated in an assisted discovery mode so as to receive input from the user for refining the ontology. For example, the assisted discovery module 1212 enables the user to provide inputs to the normalizing engine 1206 that a concept A and concept B should both be treated as Concept 1. In the assisted discovery mode, the user can refine and further, iterate the steps involved in automatic generation of the ontology. The iteration enables the ontology generation module 114 to determine a semantic network of concepts that can be more pertinent to the specific concept of interest. Further, the user can define or control the level of iteration using the parameters 502 of the configuration module 116.

In addition, the ontology generation module 114 can be configured to interact with a universal ontology 1212 while generating the semantic network for a concept of interest. The universal ontology 1212 is a database of pre-discovered semantic networks. In an embodiment, the ontology generation module 114 can be configured to retrieve normalized concepts corresponding to the concept of interest from the universal ontology universal ontology 1212 so as to improve the quality of the semantic network or reduce the processing time. In an embodiment, the ontology generation module 114 can be configured to regularly update the universal ontology 1212 with the ontology generated for the specific concept of interest. In an example, the universal ontology 1212 can be used to increase accuracy in the co-reference resolution and can serve as a starting point to generate the ontology of the concept without providing any input documents for discovering relationships.

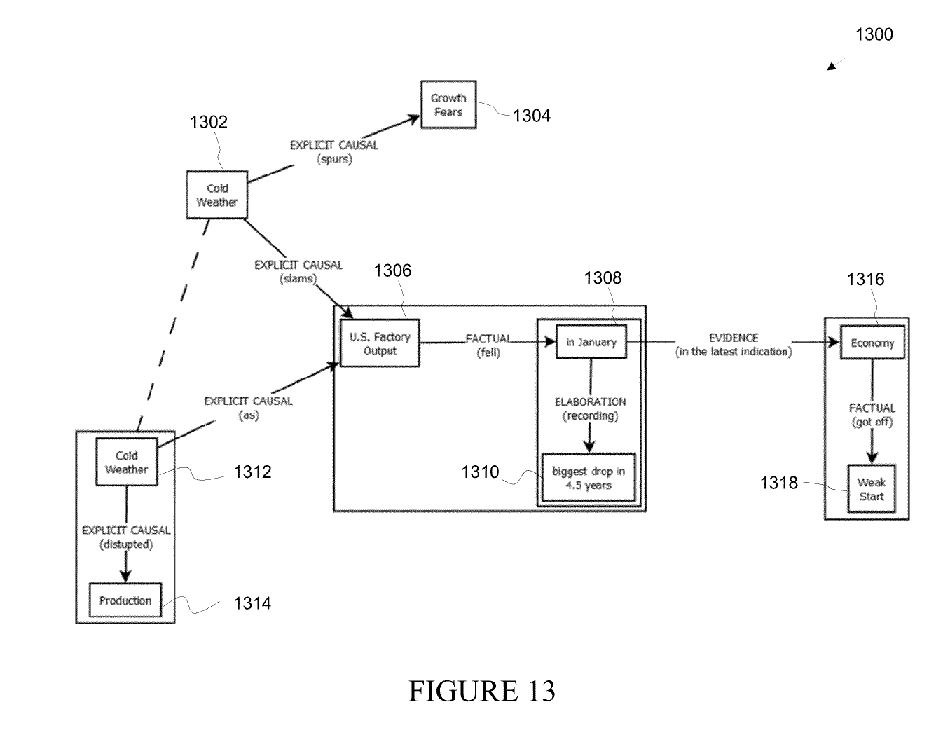

FIG. 13 illustrates an exemplary embodiment of an ontology 1300 generated using the ontology generation module 114 according to one or more embodiments of the invention. As an example and not as a limitation, the ontology 1300 illustrates a semantic network for the cluster 0 of the unstructured document 700 as shown in FIG. 11C. The cluster 0 includes two sentences S0 and S1. The sentence S0 includes “Cold weather slams U.S. factory output, spurs growth fears” and the sentence S1 includes “U.S. manufacturing output unexpectedly fell in January, recording its biggest drop in more than 4½ years, as cold weather disrupted production in the latest indication the economy got off to a weak start this year”. Further, three clauses (i.e., a clause 0, a clause 1 and a clause 3) are identified within the sentence S1. The clause 0 of the sentence includes “U.S. manufacturing output unexpectedly fell in January, recording its biggest drop in more than 4½ years”, the clause 1 includes “Cold weather disrupted production” and the clause 3 includes “The economy got off to a weak start this year”.

The ontology generation module 114 can be configured to process every clause of these two sentences (S0 & S1) such as to generate the semantic network of concepts for the cluster 0. The semantic network of FIG. 13 further depicts one or more relationships between the one or more concepts identified in the cluster 0. As described earlier, the ontology generation module 114 utilizes the relationship identification rules 1202 to determine the relationships between the one or more concepts. For example, the ontology generation module 114 determines an explicit causal relationship between a concept 1302 (i.e., cold weather) and a concept 1304 (i.e., growth fears). The concepts 1302 and 1304 are derived from the sentence S0 of the cluster 0.

Similarly, the ontology generation module 114 determines different relationships within the concepts identified in the sentence S1. The ontology generation module 114 determines a factual relationship between a concept 1306 (i.e., US factory output) and an event 1308 (i.e., in January). The concept 1306 and the event 1308 are derived from the clause 0 of the sentence 1. The ontology generation module 114 determines an elaboration related relationship between the events 1308 (i.e., in January) and 1310 (i.e., biggest drop in 4.5 years) which are also derived from the clause 0 of the sentence S1. Further, the ontology generation module 114 determines an explicit causal relationship between a concept 1312 (i.e., cold weather) and a concept 1314 (i.e., production). The concepts 1312 and 1314 are derived from the clause 1 of the sentence S1 of the cluster 0. As shown, the ontology generation module 114 determines a factual relationship between a concept 1316 (i.e., economy) and a concept 1318 (i.e., weak start). The concepts 1316 and 1318 are derived from the clause 2 of the sentence S1 of the cluster 0.

In addition, the ontology generation module 114 determines the relationships between the concepts of the different clauses of the sentence. For example, the ontology generation module 114 determines an evidence related relationship between the event 1308 and the concept 1316. The event 1308 belongs to clause 0 of sentence S1 and the concept 1316 belongs to the clause 2 of the sentence S1. Similarly, an explicit causal relationship is determined between the concept 1312 of clause 1 and 1306 of the clause 0 of the sentence 1. Furthermore, the ontology generation module 114 determines the relationships between the concepts of different clauses of the different sentences. For example, the ontology generation module 114 determines an explicit causal relationship between the 1302 of the sentence S0 and the concept 1306 of the sentence S1.

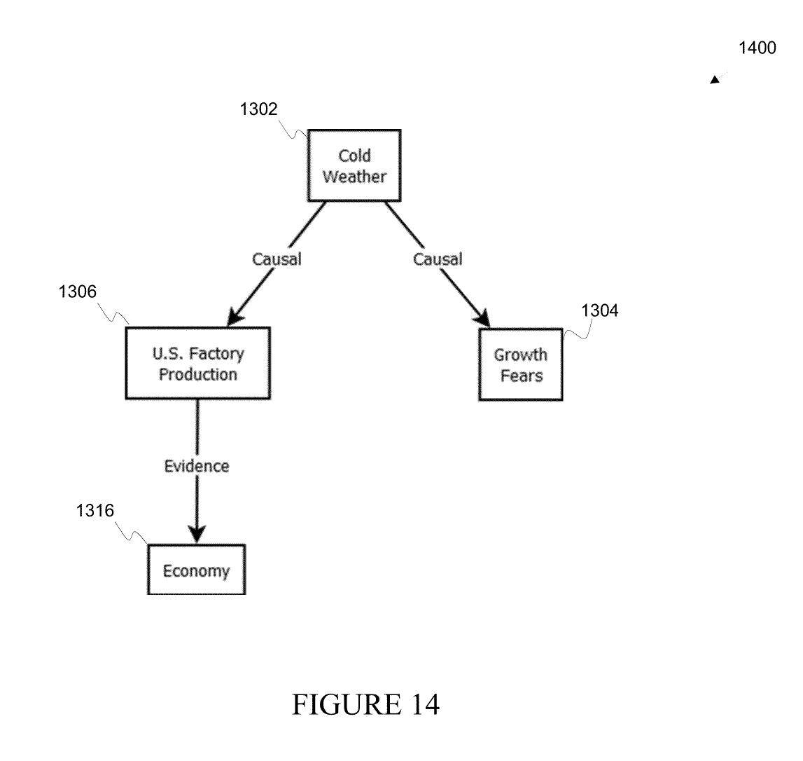

FIG. 14 illustrates an exemplary embodiment of a causal ontology 1400 generated using the ontology generation module 114 according to one or more embodiments of the invention. The causal ontology 1400 indicates a semantic network of causal relationships between the concepts of the sentences. In an embodiment, ontology generation module 114 can be configured to derive the causal ontology 1400 from the ontology 1300 that includes various relationships between the concepts including the causal relationships. The causal semantic network as shown in FIG. 14 illustrates the concepts 1302, 1304 and 1306 in a hierarch based on the causal relationships between these concepts.

According to one or more embodiments, the ontology generation module 114 can be configured to identify various events/concepts related to a specific concept of interest, determine the relationships between the identified events/concepts and the specific concept of interest, perform several levels of inferences, rank the identified events/concepts for the specific concept of interest and arrange them in hierarchical sub-structures to generate a semantic network of identified events/concepts for the specific concept of interest. The semantic network of the identified events/concepts for the specific concept of interest is referred to as the ontology for the specific concept of interest.

The ontology discovery as disclosed herein is domain independent as the process of generation of the ontology depends on the rules that consider linguistics, syntax and semantics. The methods and systems described herein can be configured to learn various linguistic based rules through the use of machine learning as well as expert defined rules. The ontology discovery can be implemented for any specific language by creating linguistic rules for the specific language and thereby, enabling the processing of ontology discovery a language independent process.

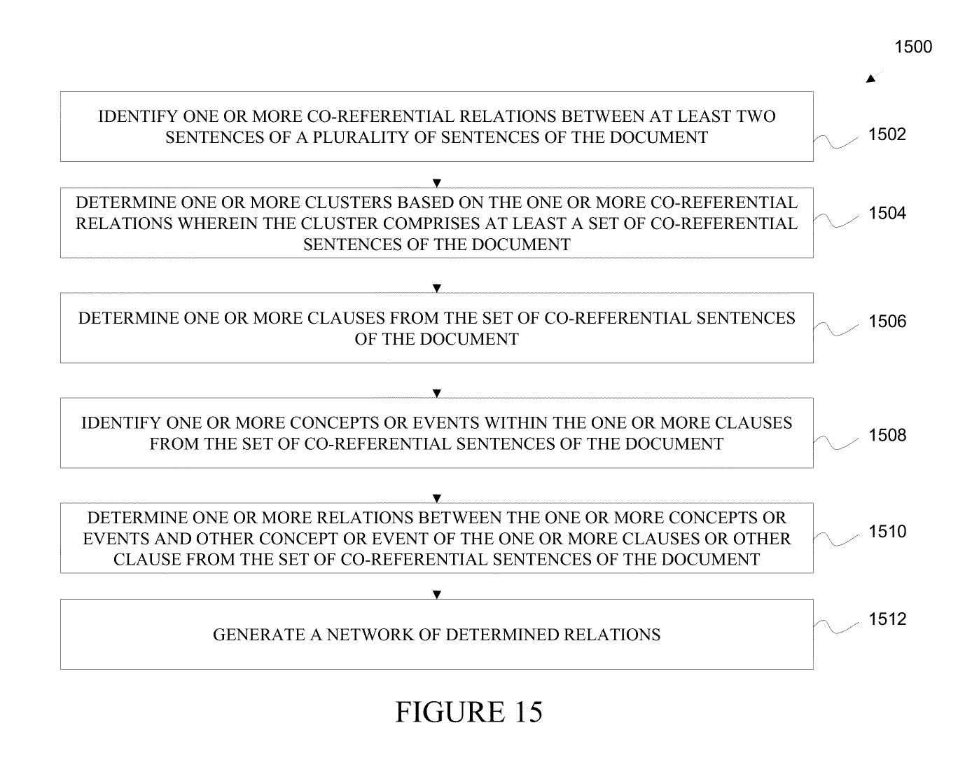

FIG. 15 illustrates an exemplary embodiment of a method 1500 for generating a semantic network for a concept according to one or more embodiments of the invention. The method 1500 initiates at step 1502 wherein one or more co-referential relationships between two sentences of a plurality of sentences of a document are identified. In an embodiment, the co-reference relationship indicates a relationship between various noun-phrases of the one or more sentences of the document. At step 1504, the method 1500 can be configured to determine one or more clusters based on the identified one or more co-referential relations. The cluster can include a set of co-referential sentences of the document.

At step 1506, the method 1500 can be configured to determine one or more clauses from the set of co-referential sentences of the document. At step 1508, the method 1500 can be configured to identify one or more concepts or events within the one or more clauses from the set of co-referential sentences of the document. At step 1510, the method 1500 can be configured to determine one or more relationships between the one or more concepts or events. In an embodiment, the relationship is determined between two concepts or events of a first clause of the sentence. In another embodiment, the relationship is determined between the between a concept or an event of a first clause and a concept or an event of a second clause of the sentence. In a yet another embodiments, the relationship is determined between the clauses of a first sentence and a second sentence of the document.

At step 1512, a network of determined relationships is generated. The network can indicate a semantic network of relationships between the concepts or events of the co-referential sentences or clauses of the document.

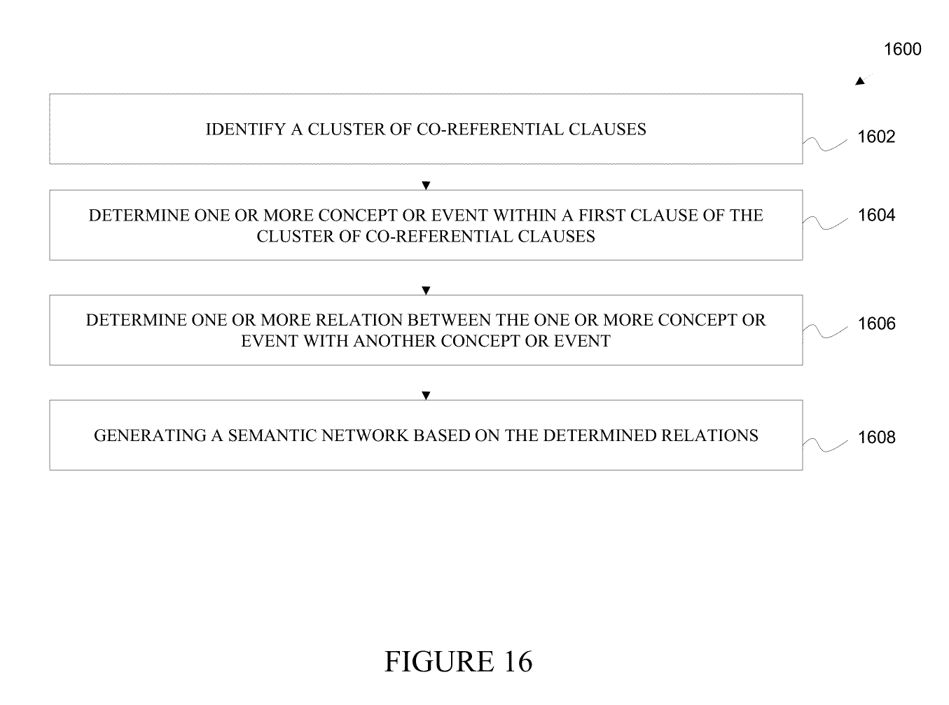

FIG. 16 illustrates an exemplary embodiment of a method 1600 for generating a semantic network a specific concept of interest according to one or more embodiments of the invention. The method 1600 initiates at step 1602, wherein a cluster of co-referential clauses is determined. At step 1604, one or more concepts or events within a first clause of the cluster of co-referential clauses are determined. In an embodiment, the first clause can be specific concept of interest provided as an input by a user. At step 1606, the method 1600 can be configured to determine one or more relationships between the identified concepts or events of the first clause or a second clause of the cluster of co-referential clauses. In an embodiment, the first clause or the second clause can be derived from the same sentence or from different sentences. At 1608, the method 1600 can be configured to generate a semantic network based on the determined relationships between the concepts or events of the first clause or the second clause of the cluster of co-referential clauses.

The methods and systems described herein offer several advantages. In an example, the system and method can be utilized for performing sentiment analysis, opinion mining and impact analysis of a corpus. The system and method disclosed herein are capable of identifying subjective and objective sentences required for the sentiment analysis via extracting causality related relationships between the concepts of the corpus.

In another example, the methods and systems disclosed herein can assist in essay grading. The methods and systems disclosed herein are capable of identifying coherence within a given text which is an important perspective for the essay grading. A computed coherence can indicate how the sentences flow from one to another and with what relations. For example, an essay with a lot of elaborations and with no causation can be graded as good essay.

Further, the methods and systems disclosed herein can assist in clustering of responses to a specific question. For example, the methods and systems disclosed herein are capable of performing semantic clustering of the responses to a given question. The clustering may be based on causal reasons. Further, the methods and systems disclosed herein can spit out all the reasons present in all the responses. Thereafter, the reasons can be normalized to provide a natural classification of responses for the question.

The methods and systems disclosed herein can perform co-reference resolution to detect the continuation of a context for detecting relationships between noun-phrases in a more elaborative manner. For example, in two sentences, one containing the cause and the other one containing the effect can be an important cue for determining continuation of the context.

The methods and systems disclosed herein can also assist in knowledge management. For example, the methods and systems disclosed herein can identify the most-important things being talked about in a given collection of documents. Further, the methods and systems disclosed herein are capable of finding all the causal concepts, clustering these causal concepts on the normalized forms, and using these clusters to map the documents so as to efficiently discover the information in the underlying documents.

The methods and systems disclosed herein can assist in ontology maintenance. For example, for a given set of articles that talk about the same representative concept, the methods and systems disclosed herein can find all causal concepts and cluster these causal concepts on normalized forms. Thereafter, a user can be shown the normalized forms to assist the user to represent that one representative concept in different ways. The methods and systems disclosed herein can also provide other nodes which can be possibly part of the ontology.

The methods and systems disclosed herein provide multiple advantages over existing methods. The deployment of a model-driven architecture in the invention ensures that the methods may be modified at run time without any programming by purely changing various attributes of the model. Such model-driven architecture is achieved by providing configurable parameters. Secondly, the invention discovers a comprehensive set of relationships that may exist between concepts and/or events embedded in the corpus. Most of the existing systems and ontologies are definitional and statistical in nature; in contrast the methods and systems disclosed are based on linguistics. This further endows such systems with tractability by ensuring that the logic behind the results is completely visible to the end-user.

Although the foregoing embodiments have been described with a certain level of detail for purposes of clarity, it is noted that certain changes and modifications can be practiced within the scope of the appended claims. Accordingly, the provided embodiments are to be considered illustrative and not restrictive, not limited by the details presented herein, and may be modified within the scope and equivalents of the appended claims.

What is claimed:

1. A computer implemented method for analyzing the text of a document, the method comprising the steps of:
identifying at least one co-referential relationship between at least two sentences of a plurality of sentences of the document;
determining at least one cluster based on the at least one co-referential relationship between the at least two sentences, wherein the at least one cluster comprises co-referential sentences of the document;
identifying at least two concepts or events within the co-referential sentences of the document;
determining at least one relationship between the at least two concepts or events; and
generating an ontology representing the at least one relationship between the at least two concepts or events.

2. The method of claim 1, wherein the step of generating the ontology comprises generating a causal ontology indicating causal relationships between the at least two concepts or events.

3. The method of claim 2, wherein the causal relationships comprises at least one of direct causal relationships, indirect causal relationships, conditional causal relationships, and implied causal relations.

4. The method of claim 1, wherein the at least one relationship between the at least two concepts or events comprises at least one of a causal relationship, conditional relationship, contrast relationship, temporal parallel relationship, temporal succession relationship, temporal simultaneous relationship, contra expectation relationship, reasoning based relationship, justification relationship, elaboration relationship, result based relationship, conclusion based relationship, comparison relationship, and co-occurrence relation.

5. The method of claim 1, further comprising the step of:
displaying the ontology on a display interface to illustrate the at least one relationship between the at least two concepts or events.

6. The method of claim 1, wherein the ontology comprises a plurality of nodes corresponding to concepts or events identified in the document.

7. The method of claim 6, further comprising the step of:
selecting at least one node from the plurality of the nodes to identify at least a portion of the document, wherein at least one concept or event corresponding to the node is identified within the at least portion of the document.

8. The method of claim 1, further comprising the step of:
generating a document map for the document.

9. The method of claim 8, wherein the document map comprises at least one of:
a graph of the at least one co-referential relationship between the at least two sentences of the plurality of the sentences of the document; and
a language based structure of the plurality of the sentences of the document.

10. The method of claim 8, further comprising the step of:
displaying the document map on a display interface.

11. The method of claim 8, further comprising the step of:
assigning a score with the at least one co-referential relationship between the at least two sentences of the plurality of the sentences of the document

12. The method of claim 11, further comprising the steps of:
computing a threshold value for the score; and
generating a cluster for the document, wherein the cluster comprises the at least two sentences of the plurality of the sentences of the document such that the score with the at least one co-referential relationship between the at least two sentences is greater than the threshold value.

13. The method of claim 12, further comprising the step of:
displaying the cluster on a display interface.

14. The method of claim 1, further comprising the step of:
managing at least one rule comprising information to determine the at least one relationship between the at least two concepts or events.

15. The method of claim 14, wherein the managing comprises at least one of adding, removing, and updating the at least one rule.

16. The method of claim 1, further comprising the step of:
receiving an input from a user, wherein the input comprises selection of the at least one rule to determine the at least one relationship between the at least two concepts or events.

17. The method of claim 14, wherein the at least one relationship between the at least one concept or event and the other concept or event, comprises at least one of causal relationship, conditional relationship, contrast relationship, temporal parallel relationship, temporal succession relationship, temporal simultaneous relationship, contra expectation relationship, reasoning based relationship, justification relationship, elaboration relationship, result based relationship, conclusion based relationship, comparison relationship, and co-occurrence relation.

18. The method of claim 1, wherein the information used to determine the at least one relationship between the at least two concepts or events comprises domain specific information.

19. The method of claim 1, wherein the at least one relationship is defined by a set of language related cue words in combination with contextual or collocated words.

20. The method of claim 1, further comprising:
extracting at least a portion of the document from a corpus.

21. The method of claim 1, further comprising:
normalizing the at least one relationship between the at least two concepts or events.

22. The method of claim 1, wherein identifying the at least two concepts or events within the co-referential sentences of the document comprises:
identifying at least one noun within at least one clause of the co-referential sentences.

23. The method of claim 22, further comprising at least one of:
converting at least one multi-word noun into a compound noun; and
converting at least one prepositional clause into the compound noun.

24. One or more computer-storage non-transitory media having computer-executable instructions embodied thereon that, when executed, perform a method for analyzing text, the method comprising:
identifying a cluster of co-referential clauses;
determining at least one concept or event within a first clause of the cluster of co-referential clauses;
determining at least one relationship between the at least one concept or event with another concept or event, wherein the another concept or event is found in the first clause or a second clause of the of the cluster of co-referential clauses; and
generating a semantic network based on the determined at least one relationship between the at least one concept or event with another concept or event.

25. A computer system having a processor for executing instructions for analyzing text, the system comprising:
a co-reference resolution module configured to identify at least one co-referential relationship between at least two sentences of a plurality of the sentences of the document;
a cluster determination module configured to determine at least one cluster based on the at least one co-referential relationship wherein the at least one cluster comprises co-referential sentences of the document; and
an ontology generation module comprising:
a concept identifier configured to identify at least two concepts or events within the co-referential sentences of the document;
means for applying relationship identification rules comprising information to identify at least one relationship between the at least two concepts or events within the co-referential sentences of the document; and
an inference engine configured to generate an ontology indicating the at least one relationship between the at least two concepts or events within the co-referential sentences of the document.

26. The system of claim 25, wherein the ontology generation module is configured to generate the ontology independent of the language of the document.

27. The system of claim 25, wherein the ontology generation module is configured to generate the ontology independent of the domain of the document.

28. The system of claim 25, wherein the ontology generation module is configured to generate a tractable ontology.

29. A computer system having a processor for executing instructions for analyzing the text of a document, the system comprising:
a language processing module configured to execute at least one language processing technique so as to identify at least two concepts or events within at least one set of co-referential clauses of the document;
an ontology generation module comprising:
means for applying relationship identification rules to identify at least one relationship between the at least two concepts or events within the at least one set of co-referential clauses;
an inference engine configured to generate an ontology indicating the at least one relationship between the at least two concepts or events within the at least one set of co-referential clauses; and
a configuration module comprising a first parameter for managing the relationship identification rules, wherein values for the first parameter are provided by a user.

30. The system of claim 29, wherein the values for the first parameter comprising input values required for at least one of: defining at least one relationship identification rule, adding the least one relationship identification rule, modifying an existing relationship identification rule and removing the existing relationship identification rule.

31. The system of claim 29, wherein the configuration module further comprising a second parameter for controlling the execution of the least one language processing technique.
